(19) United States
(12) Patent Application Publication
(10) Pub. No.: US 2026/0101254 A1
(43) Pub. Date: Apr. 9, 2026

(54) METHOD AND APPARATUS FOR MOBILITY ENHANCEMENT OF USER EQUIPMENT IN COMMUNICATION NETWORK

(71) Applicant: Electronics and Telecommunications Research Institute, Daejeon (KR)

(72) Inventors: Yong Sun KIM, Daejeon (KR); Kapseok CHANG, Daejeon (KR); Young Jo KO, Daejeon (KR)

(21) Appl. No.: 19/349,852

(22) Filed: Oct. 3, 2025

(30) Foreign Application Priority Data
Oct. 4, 2024 (KR) 10-2024-0135186
Nov. 8, 2024 (KR) 10-2024-0158142
Mar. 17, 2025 (KR) 10-2025-0034143
Mar. 28, 2025 (KR) 10-2025-0040265
Apr. 9, 2025 (KR) 10-2025-0046153
Apr. 9, 2025 (KR) 10-2025-0046354
May 9, 2025 (KR) 10-2025-0060689
Sep. 30, 2025 (KR) 10-2025-0142138

(51) Int. Cl. H04W 36/08; H04B 7/06; H04B 17/318; H04W 76/20

(52) U.S. Cl. CPC H04W 36/08; H04B 7/0626; H04B 17/318; H04W 76/20

(57) ABSTRACT

Disclosed are a method and an apparatus for terminal mobility enhancement in a communication network. A method of a terminal may comprise: receiving a plurality of CSI-RSs respectively from a plurality of candidate cells; measuring a signal strength of each of the plurality of CSI-RSs; transmitting, to the source cell, a measurement result of the signal strengths; receiving, from the source cell, a cell switch command for a target cell determined among the plurality of candidate cells; and transmitting, for performing cell switching from the source cell to the target cell based on the cell switch command, a multiplexed message including a CSI report for one or more CSI-RSs among the plurality of CSI-RSs and an RRC reconfiguration complete message.

### CROSS-REFERENCE TO RELATED APPLICATIONS

This application claims priority to Korean Patent Applications No. 10-2024-0135186, filed on Oct. 4, 2024, No. 10-2024-0158142, filed on Nov. 8, 2024, No. 10-2025-0034143, filed on Mar. 17, 2025, No. 10-2025-0040265, filed on Mar. 28, 2025, No. 10-2025-0046153, filed on Apr. 9, 2025, No. 10-2025-0046354, filed on Apr. 9, 2025, No. 10-2025-0060689, filed on May 9, 2025, and No. 10-2025-0142138, filed on Sep. 30, 2025, with the Korean Intellectual Property Office (KIPO), the entire contents of which are hereby incorporated by reference.

### BACKGROUND

### 1. Technical Field

The present disclosure relates to a low layer triggered mobility (LTM) technique for a terminal, and more particularly, to a method and apparatus for enhancing terminal mobility based on channel state information-reference signal (CSI-RS) measurement.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In a communication system, beam management may be a procedure for aligning uplink (UL) and downlink (DL) beams between a terminal (e.g. user equipment UE) and a base station. The beam management may consist of three stages: beam measurement, beam reporting, and beam indication. Through beam management operations, the terminal or base station may select an optimal beam, and data transmission and reception may be performed between them through the selected optimal beam.

When the terminal moves in the communication system, a beam tracking procedure may be required. The beam tracking procedure may refer to a procedure of continuously performing beam measurement on neighbor beams around the optimal beam selected through beam management to update a beam measurement set.

Through the beam tracking procedure, the existing optimal beam may be changed, and in this case, beam switching may occur at the base station. When the terminal moves within the same cell or between distributed units (DUs) having the same physical cell identity (PCI), the quality of service provided to the terminal may be maintained through beam switching of the base station. However, the terminal may move from the current cell to a neighbor cell due to fast mobility, and in this case, a handover of the terminal, for example, cell switching, may occur.

As higher frequency bands are used in the communication system, the cell size of the communication system may become smaller, resulting in frequent handovers of the terminal. Such frequent handovers of the terminal may increase the power consumption of the base station or terminal and degrade the quality of service provided to the terminal. In particular, when the terminal performs a separate beam management procedure or a channel state information (CSI) acquisition procedure after a fast handover, the quality of service difference before and after the handover may become significant. Therefore, there is a need for a method capable of maintaining the same service quality before and after the terminal's handover.

### SUMMARY

The present disclosure for resolving the above-described problems is directed to providing a method and apparatus for enhancing terminal mobility based on channel state information-reference signal (CSI-RS) measurement.

A method of a terminal, according to an exemplary embodiment of the present disclosure, may comprise: receiving, from a source cell, a radio resource control (RRC) reconfiguration message; measuring a signal strength of each of a plurality of channel state information-reference signals (CSI-RSs) respectively received from a plurality of candidate cells, based on the RRC reconfiguration message; transmitting, to the source cell, a measurement result of the signal strengths; receiving, from the source cell, a CSI-RS activation indication message for each of at least two candidate cells among the plurality of candidate cells, based on the measurement result of the signal strengths; receiving, from the source cell, a cell switch command (CSC) for a target cell among the at least two candidate cells; and transmitting, for performing cell switching from the source cell to the target cell based on the cell switch command, a multiplexed message including a CSI report based on a CSI measurement result for the target cell and an RRC reconfiguration complete message.

The method may further comprise, before receiving the cell switch command, measuring, based on the CSI-RS activation indication message, CSI for the CSI-RS of each of the at least two candidate cells.

The method may further comprise, after receiving the cell switch command, measuring, based on at least one of the cell switch command or a CSI measurement indicator field included in the cell switch command, CSI for the CSI-RS of the target cell among the at least two candidate cells.

The transmitting of the multiplexed message may comprise: receiving, from the target cell, a CSI report request; and transmitting, to the target cell, the multiplexed message including a physical uplink shared channel (PUSCH) to which the RRC reconfiguration complete message is allocated and an uplink control indicator (UCI) control channel to which the CSI report for the target cell is allocated, based on the CSI report request.

The method may further comprise: based on the CSI report for the target cell being invalid at a time of receiving the CSI report request, transmitting, to the target cell, an invalid CSI report, wherein the invalid CSI report may be determined based on a combination of a channel quality indicator (CQI), a precoding matrix indicator (PMI), or a rank indicator (RI) of the CSI measurement result.

The transmitting of the multiplexed message may comprise: transmitting the multiplexed message using a periodically allocated PUSCH.

The method may further comprise: based on the CSI report for the target cell being invalid at a time of allocating the PUSCH, transmitting, to the target cell, an invalid CSI report.

The RRC reconfiguration message may include a list of CSI-RSs to be measured for signal strength, and the measuring of the signal strength of each of the plurality of CSI-RSs may comprise: excluding, from the list, at least one CSI-RS showing a decreasing trend in signal strength among the plurality of CSI-RSs.

The RRC reconfiguration message may include a list of CSI-RSs to be measured for signal strength, and the measuring of the signal strength of each of the plurality of CSI-RSs may comprise: transmitting, to the source cell, a measurement exclusion request for at least one CSI-RS showing a decreasing trend in signal strength among the plurality of CSI-RSs; and receiving, from the source cell, an updated signal strength measurement target list from which the at least one CSI-RS is excluded.

A terminal, according to an exemplary embodiment of the present disclosure, may comprise: at least one processor, wherein the at least one processor may cause the terminal to perform: receiving, from a source cell, a radio resource control (RRC) reconfiguration message; measuring a signal strength of each of a plurality of channel state information-reference signals (CSI-RSs) respectively received from a plurality of candidate cells, based on the RRC reconfiguration message; transmitting, to the source cell, a measurement result of the signal strengths; receiving, from the source cell, a CSI-RS activation indication message for each of at least two candidate cells among the plurality of candidate cells, based on the measurement result of the signal strengths; receiving, from the source cell, a cell switch command (CSC) for a target cell among the at least two candidate cells; and transmitting, for performing cell switching from the source cell to the target cell based on the cell switch command, a multiplexed message including a CSI report based on a CSI measurement result for the target cell and an RRC reconfiguration complete message.

The at least one processor may further cause the terminal to perform: before receiving the cell switch command, measuring, based on the CSI-RS activation indication message, CSI for the CSI-RS of each of the at least two candidate cells.

The at least one processor may further cause the terminal to perform: after receiving the cell switch command, measuring, based on at least one of the cell switch command or a CSI measurement indicator field included in the cell switch command, CSI for the CSI-RS of the target cell among the at least two candidate cells.

In the transmitting of the multiplexed message, the at least one processor may cause the terminal to perform: receiving, from the target cell, a CSI report request; and transmitting, to the target cell, the multiplexed message including a physical uplink shared channel (PUSCH) to which the RRC reconfiguration complete message is allocated and an uplink control indicator (UCI) control channel to which the CSI report for the target cell is allocated, based on the CSI report request.

The at least one processor may further cause the terminal to perform: based on the CSI report for the target cell being invalid at a time of receiving the CSI report request, transmitting, to the target cell, an invalid CSI report, wherein the invalid CSI report may be determined based on a combination of a channel quality indicator (CQI), a precoding matrix indicator (PMI), or a rank indicator (RI) of the CSI measurement result.

In the transmitting of the multiplexed message, the at least one processor may cause the terminal to perform: transmitting the multiplexed message using a periodically allocated PUSCH.

The at least one processor may further cause the terminal to perform: based on the CSI report for the target cell being invalid at a time of allocating the PUSCH, transmitting, to the target cell, an invalid CSI report.

The RRC reconfiguration message may include a list of CSI-RSs to be measured for signal strength, and in the measuring of the signal strength of each of the plurality of CSI-RSs, the at least one processor may cause the terminal to perform: excluding, from the list, at least one CSI-RS showing a decreasing trend in signal strength among the plurality of CSI-RSs.

The RRC reconfiguration message may include a list of CSI-RSs to be measured for signal strength, and in the measuring of the signal strength of each of the plurality of CSI-RSs, the at least one processor may cause the terminal to perform: transmitting, to the source cell, a measurement exclusion request for at least one CSI-RS showing a decreasing trend in signal strength among the plurality of CSI-RSs; and receiving, from the source cell, an updated signal strength measurement target list from which the at least one CSI-RS is excluded.

A method of a target cell, according to an exemplary embodiment of the present disclosure, may comprise: transmitting, to a terminal, at least one channel state information-reference signal (CSI-RS) based on a CSI-RS request received from a source cell; and after the terminal receives a cell switch command from the source cell, receiving, from the terminal, a multiplexed message of a CSI report for the target cell and a radio resource control (RRC) reconfiguration complete message.

The receiving of the multiplexed message may comprise: transmitting, to the terminal, a CSI report request; and receiving, from the terminal, the multiplexed message through one physical uplink shared channel (PUSCH) based on the CSI report request.

According to the present disclosure, a terminal can acquire CSI for candidate cells before performing cell switching (e.g. handover). The terminal can increase the accuracy and rapidity of cell switching to a target cell and can prevent degradation of service quality after the cell switching.

The terminal can acquire CSI for candidate cells in an intra-frequency band and an inter-frequency band, respectively, and can perform flexible mobility management in various frequency bands.

The terminal can transmit a radio resource control (RRC) reconfiguration complete message and CSI to the target cell by multiplexing them, can reduce a blind decoding burden of the target cell, and can prevent retransmission or procedure delay caused by initial reception failure.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating exemplary embodiments of cell switching in a communication network.

FIG. 4 is a conceptual diagram illustrating exemplary embodiments of cell switching in a communication network.

FIG. 5 is a sequence chart illustrating an exemplary embodiment of a lower layer triggered mobility (LTM) procedure of a terminal in a communication network.

FIG. 6 is a conceptual diagram illustrating an exemplary embodiment of a cell switch command format.

FIG. 7 is a conceptual diagram illustrating an exemplary embodiment of a communication network.

FIG. 8 is a sequence chart illustrating an exemplary embodiment of an LTM procedure for a terminal based on CSI-RS measurement.

FIG. 9 is a flowchart illustrating an exemplary embodiment of changing a CSI-RS measurement list at a terminal.

FIG. 10 is a flowchart illustrating an exemplary embodiment of changing a CSI-RS measurement list at a terminal.

FIG. 11 is a flowchart illustrating an exemplary embodiment of changing a CSI-RS measurement list at a terminal.

FIG. 12 is a flowchart illustrating an exemplary embodiment of changing a CSI-RS measurement list at a base station.

FIG. 13 is a flowchart illustrating an exemplary embodiment of changing a CSI-RS measurement list at a base station.

FIG. 14 is a flowchart illustrating an exemplary embodiment of changing a CSI-RS measurement list at a terminal and a base station.

FIG. 15 is a flowchart illustrating an exemplary embodiment of changing a CSI-RS measurement list at a terminal and a base station.

FIG. 16 is a flowchart illustrating an exemplary embodiment of changing a CSI-RS measurement list at a terminal and a base station.

FIG. 17 is a conceptual diagram illustrating an exemplary embodiment of changing a CSI-RS measurement list at a terminal or a base station.

FIG. 18 is a sequence chart illustrating an exemplary embodiment of acquiring CSI before cell switching of a terminal.

FIG. 19 is a sequence chart illustrating an exemplary embodiment of acquiring CSI before cell switching of a terminal.

FIG. 20 is a sequence chart illustrating an exemplary embodiment of acquiring CSI before cell switching of a terminal.

FIG. 21 is a sequence chart illustrating an exemplary embodiment of acquiring CSI during cell switching of a terminal.

FIG. 22 is a sequence chart illustrating an exemplary embodiment of acquiring CSI during cell switching of a terminal.

FIG. 23 is a sequence chart illustrating an exemplary embodiment of acquiring CSI during cell switching of a terminal.

FIG. 24 is a sequence chart illustrating an exemplary embodiment of acquiring CSI after cell switching of a terminal.

FIG. 25 is a sequence chart illustrating an exemplary embodiment of a CSI-RS downlink transmission scheme.

FIG. 26 is a sequence chart illustrating an exemplary embodiment of measuring CSI before a terminal receives a cell switch command.

FIG. 27 is a sequence chart illustrating an exemplary embodiment of measuring CSI before a terminal receives a cell switch command.

FIG. 28 is a sequence chart illustrating an exemplary embodiment of measuring CSI after a terminal receives a cell switch command.

FIG. 29 is a sequence chart illustrating an exemplary embodiment of measuring CSI after a terminal receives a cell switch command.

FIG. 30 is a conceptual diagram illustrating an exemplary embodiment of a cell switch command format including a field for requesting CSI measurement of a terminal.

FIG. 31 is a conceptual diagram illustrating an exemplary embodiment of a cell switch command format including a field for requesting CSI measurement reporting of a terminal.

FIG. 32 is a conceptual diagram illustrating an exemplary embodiment of a cell switch command format including a field for requesting CSI measurement and reporting of a terminal.

FIG. 33 is a flowchart illustrating an exemplary embodiment of measuring and reporting CSI based on reception of a cell switch command of a terminal.

FIG. 34 is a flowchart illustrating an exemplary embodiment of measuring and reporting CSI based on reception of a cell switch command of a terminal.

FIG. 35 is a sequence chart illustrating an exemplary embodiment of dynamic-grant-based CSI reporting of a terminal.

FIG. 36 is a conceptual diagram illustrating an exemplary embodiment of a timeline of CSI reporting of a terminal.

FIG. 37 is a conceptual diagram illustrating an exemplary embodiment of a timeline of CSI reporting of a terminal.

FIG. 38 is a conceptual diagram illustrating an exemplary embodiment of a timeline of CSI reporting of a terminal.

FIG. 39 is a sequence chart illustrating an exemplary embodiment of dynamic-grant-based CSI reporting of a terminal.

FIG. 40 is a sequence chart illustrating an exemplary embodiment of dynamic-grant-based multiplexed reporting of an RRC reconfiguration complete message and CSI by a terminal.

FIG. 41 is a sequence chart illustrating an exemplary embodiment of dynamic-grant-based multiplexed reporting of an RRC reconfiguration complete message and CSI by a terminal.

FIG. 42 is a sequence chart illustrating an exemplary embodiment of configured-grant-based multiplexed reporting of an RRC reconfiguration complete message and CSI by a terminal.

FIG. 43 is a sequence chart illustrating an exemplary embodiment of configured-grant-based multiplexed reporting of an RRC reconfiguration complete message and CSI by a terminal.

FIG. 44 is a sequence chart illustrating an exemplary embodiment of random-access-based CSI multiplexed reporting of a terminal.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or as a phrase including “in response to ˜”. In other words, a phrase including “when ˜” may be interpreted as being the same as or similar to a phrase including “based on ˜” or a phrase including “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

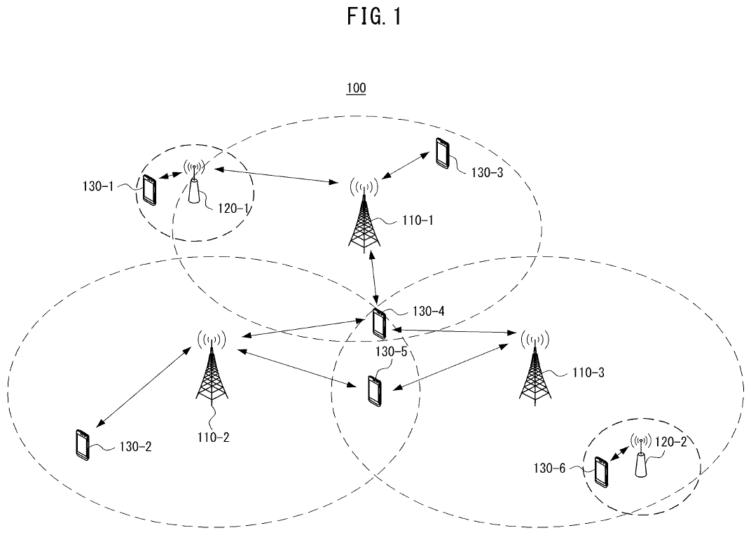

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

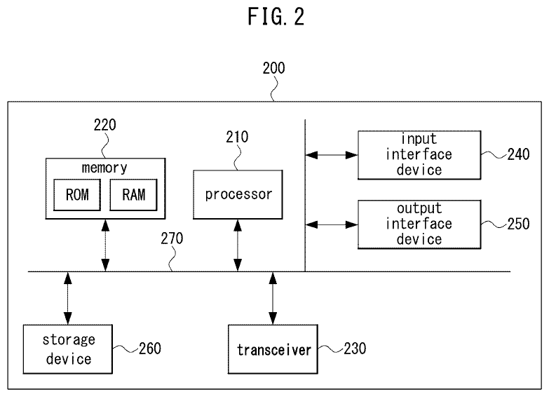

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

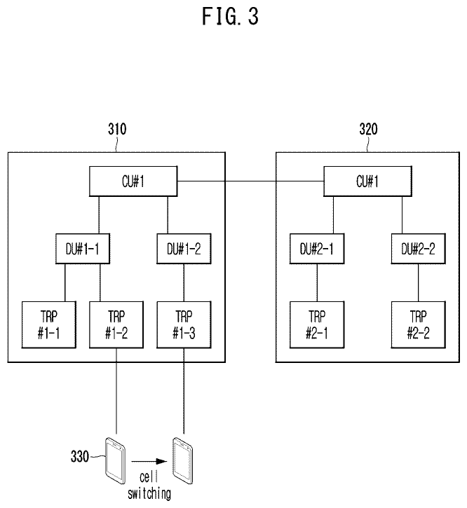

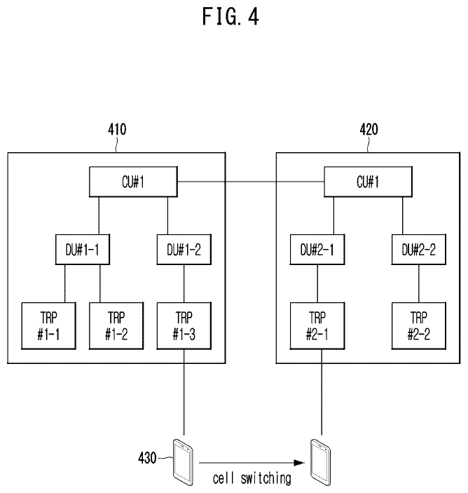

FIGS. 3 and 4 are conceptual diagrams illustrating exemplary embodiments of cell switching in a communication network.

A central unit (CU) illustrated in FIGS. 3 and 4 may be a base station (e.g. gNB), a distributed unit (DU) may be a device performing a part of baseband functions of the base station, and a transmission and reception point (TRP) may be a device connected to a terminal (e.g. user equipment (UE)) through a radio link.

Referring to FIGS. 3 and 4, a first cell 310 may be formed by a first base station (e.g. a first CU CU #1), a first-1 DU DU #1-1 and a first-2 DU DU #1-2 connected to the first CU CU #1, a first-1 TRP TRP #1-1 and a first-2 TRP TRP #1-2 connected to the first-1 DU DU #1-1, and a first-3 TRP TRP #1-3 connected to the first-2 DU DU #1-2. A second cell 320 may be formed by a second base station (e.g. a second CU CU #2), a second-1 DU DU #2-1 and a second-2 DU DU #2-2 connected to the second CU CU #2, a second-1 TRP TRP #2-1 connected to the second-1 DU DU #2-1, and a second-2 TRP TRP #2-2 connected to the second-2 DU DU #2-2.

The first-1 DU and the first-2 DU or the second-1 DU and the second-2 DU may be distinguished from each other by different physical cell IDs (PCIs). The first CU, the first-1 DU, or the first-2 DU may be connected through F1 interfaces. The first-1 DU, the first-1 TRP, and the first-2 TRP may be connected through F1 interfaces. The first-2 DU and the first-3 TRP may be connected through an F1 interface. The second CU, the second-1 DU, or the second-2 DU may be connected through F1 interfaces. The second-1 DU and the second-1 TRP may be through an F1 interface. The second-2 DU and the second-2 TRP may be connected through an F1 interface.

As illustrated in FIG. 3, a terminal 330 may move toward the first-3 TRP while being connected to the first-2 TRP. Since the first-2 TRP and the first-3 TRP are connected to different DUs, the terminal 330 may be considered to move between cells having different PCIs, that is, from the first-1 DU to the first-2 DU. The terminal 330 may perform handover, for example, cell switching (cell transition), by releasing the connection with the first-1 DU and establishing a connection with the first-2 DU. Here, since the terminal 330 performs cell switching within the same CU, that is, the first CU, a delay time caused by cell switching may not be long.

As illustrated in FIG. 4, a terminal 430 may move toward the second-1 TRP of the second CU while being connected to the first-3 TRP of the first CU. In this case, by moving between different CUs, the terminal 430 may perform cell switching in a manner different from that illustrated in FIG. 3. For example, a source DU (i.e. the first-2 DU) of the first-3 TRP to which the terminal 430 is connected may request cell switching of the terminal 430 to the first CU through the F1 interface. The first CU may request cell switching of the terminal 430 to the second CU through an Xn interface and may receive cell switching approval from the second CU. The first CU may forward the received cell switching approval to the first-2 DU, and the first-2 DU may transmit a cell switching indication to the terminal 430 via the first-3 TRP. As described above, when the terminal 430 performs cell switching between different CUs, the delay time may be longer compared to the cell switching within the same CU described above.

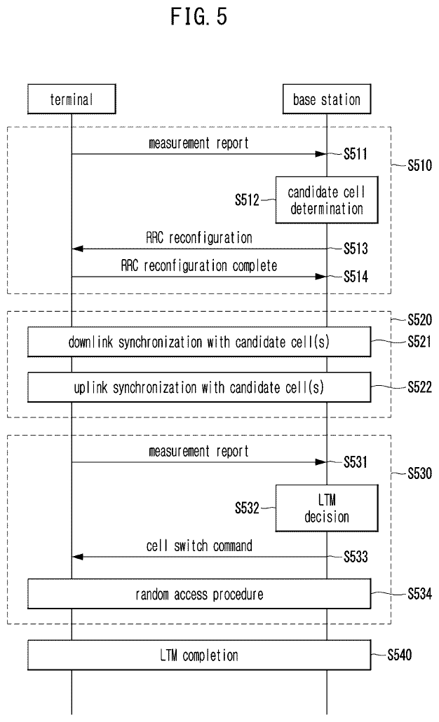

FIG. 5 is a sequence chart illustrating an exemplary embodiment of a lower layer triggered mobility (LTM) procedure of a terminal in a communication network.

Referring to FIG. 5, an LTM procedure of a terminal may include an LTM preparation stage S510, an early synchronization (early sync) stage S520, an LTM execution stage S530, and an LTM completion stage S540.

The terminal may be in a state of being RRC-connected with a base station. In the LTM preparation stage S510, the terminal may transmit a measurement report including signal strengths (e.g. signal reception powers such as layer 1 reference signal received powers (L1-RSRPs)) of at least one neighbor cell to the base station (S511). The base station may determine candidate cell(s) or candidate beam(s) for performing LTM of the terminal based on the measurement report received from the terminal (S512). The base station may transmit an RRC reconfiguration message including configuration information of the determined candidate cell(s) or candidate beam(s) to the terminal (S513). The configuration information may include an index or a PCI of each candidate cell or candidate beam. The terminal may transmit an RRC reconfiguration complete message to the base station based on the RRC reconfiguration message received from the base station (S514).

When the LTM preparation stage S510 is completed, each candidate cell determined by the base station may perform the early synchronization stage S520 with the terminal. The terminal may perform downlink (DL) synchronization with each candidate cell (S521) and may also perform uplink (UL) synchronization with each candidate cell (S522). According to an exemplary embodiment, the early synchronization stage S520 may be omitted.

When synchronization between the terminal and each candidate cell is acquired, the terminal may transmit, to the base station, a measurement report including signal strengths (e.g. reception powers) of signals transmitted from at least one neighbor cell to the terminal (S531). The base station may determine LTM of the terminal based on the received measurement report (S532). The base station may transmit a cell switch command to the terminal (S533). The base station may transmit the cell switch command in a MAC CE format. Based on the cell switch command, the terminal may release a connection with a cell (e.g. source cell) to which the terminal is currently connected and may establish a connection with a cell to be switched, for example, a candidate cell. The terminal may perform a random access procedure (i.e. random access channel (RACH) procedure) with the candidate cell (S534). When the random access procedure between the terminal and the candidate cell is completed, the terminal may complete the LTM procedure (S540).

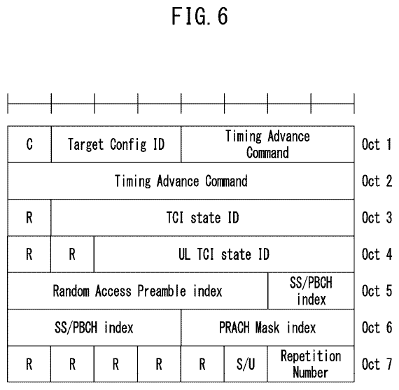

FIG. 6 is a conceptual diagram illustrating an exemplary embodiment of a cell switch command format.

Referring to FIG. 6, a cell switch command may be in a MAC CE format and may include a MAC subheader and a MAC payload. For convenience of description, the MAC payload is illustrated in FIG. 6.

The MAC payload may include a plurality of fields. A C field of the MAC payload may indicate presence of contention-free random access resources. When a value of the C field is 1, it may indicate the presence of resources, and when the value is 0, it may indicate that resources are absent. Each R field may be a reserved bit and may be set to a value of 0. A target configuration ID field may indicate a configuration index of a candidate cell (i.e. target cell) to be applied to LTM cell switching of a terminal. The length of the target configuration ID field may be 3 bits. A timing advance command (TAC) field may indicate whether a TA value of the target cell is valid. For example, when the TAC field value is set to ‘FFF’, it may indicate that there is no valid timing adjustment, and when the TAC field value is set to another value, it may indicate that there is timing adjustment based on the corresponding value. The length of the TAC field may be 12 bits. A transmission configuration indicator (TCI) state ID field may indicate a TCI state of the target cell. The length of the TCI state ID field may be 7 bits. A UL TCI state ID field may indicate a UL TCI state of the target cell. The length of the UL TCI state ID field may be 6 bits. A random access preamble index field may indicate a preamble index of random access resources. The length of the random access preamble index field may be 6 bits. A synchronization signal/physical broadcast channel (SS/PBCH) index field may indicate an SS/PBCH block that determines a RACH occasion for PRACH transmission. The length of the SS/PBCH index field may be 6 bits. A PRACH mask index field may indicate RACH occasions associated with SS/PBCH blocks for PRACH transmission. When a repetition number field value described below is not 0, the PRACH mask index field may be ignored. The length of the PRACH mask index field may be 4 bits. An S/U field may indicate a UL carrier to be used for PRACH transmission. When a value of the S/U field is 1, Supplementary Uplink (SUL) may be used, and when the value is another value, Normal Uplink (NUL) may be used. The length of the S/U field may be 1 bit. The repetition number field may indicate a number of repetitions of Msg1 transmitted by the terminal to the base station in contention-free random access. When a value of the repetition number field is 1, the number of repetitions may be 2, when the value is 2, the number of repetitions may be 4, and when the value is 3, the number of repetitions may be 8. The length of the repetition number field may be 2 bits.

Referring again to FIG. 5, the terminal may perform cell switching based on beam measurement. In this case, the terminal may separately perform a beam management procedure. In other words, since the terminal is not able to transmit and receive data with the base station while performing the cell switching operation, degradation of service quality may occur. Accordingly, the terminal may perform beam measurement and beam management before performing the cell switching operation.

Meanwhile, even when the terminal performs a beam management procedure before performing cell switching, it may not be guaranteed that the same quality of service is provided. For example, the base station may determine a Modulation and Coding Scheme (MCS) for data transmission between beams configured through beam management. The base station may determine the MCS based on CSI received from the terminal. The base station may transmit data conservatively before receiving CSI from the terminal. For example, although the base station is able to apply an MCS of 64 quadrature amplitude modulation (QAM), if CSI is not received, the base station may apply an MCS of 16 QAM, thereby causing degradation of service quality.

According to the 3GPP standards, the terminal may measure CSI-RS for each of a plurality of candidate cells, and when a specific event occurs, the terminal may perform CSI-RS measurement reporting. Events in which the terminal performs CSI-RS measurement reporting are as shown in Table 1 below.

TABLE 1

| Event | Description |
|---|---|
| Event LTM2 | A beam of a serving cell becomes worse |
| | than an absolute threshold |
| Event LTM3 | A beam of a candidate cell becomes better |
| | than a beam of the serving cell by an offset |
| Event LTM4 | A beam of a candidate cell becomes better |
| | than an absolute threshold |
| Event LTM5 | A beam of the serving cell becomes worse |
| | than a first absolute threshold and a beam of |
| | a candidate cell becomes better than a |
| | second absolute threshold |

When measurement values of CSI-RSs that are continuously transmitted from a candidate cell determined for LTM satisfy at least one of four events disclosed in Table 1, the terminal may transmit a CSI-RS measurement report to the base station.

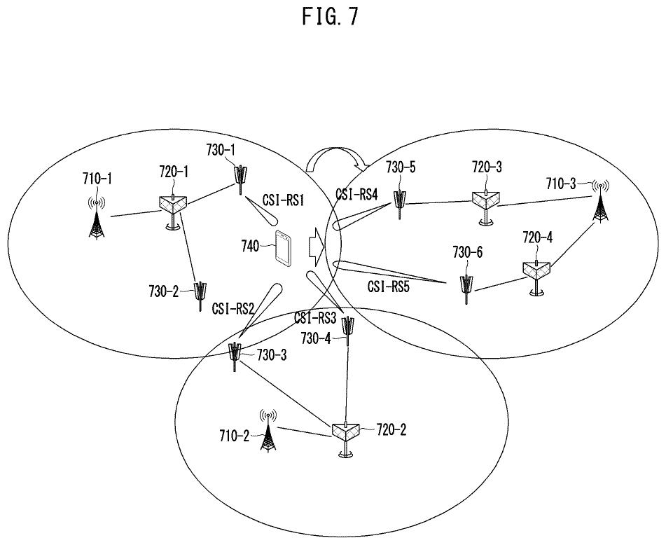

FIG. 7 is a conceptual diagram illustrating an exemplary embodiment of a communication network.

Referring to FIG. 7, a communication network may include a plurality of cells respectively managed by a plurality of base stations, for example, a first base station 710-1, a second base station 710-2, and a third base station 710-3.

In a cell of the first base station 710-1, a first DU 720-1 connected to the first base station 710-1, and a first TRP 730-1 and a second TRP 730-2 connected to the first DU 720-1 may be located. In a cell of the second base station 710-2, a second DU 720-2 connected to the second base station 710-2, and a third TRP 730-3 and a fourth TRP 730-4 connected to the second DU 720-2 may be located. In a cell of the third base station 710-3, a third DU 720-3 and a fourth DU 720-4 connected to the third base station 710-3, a fifth TRP 730-5 connected to the third DU 720-3, and a sixth TRP 730-6 connected to the fourth DU 720-4 may be located.

A terminal 740 may be located in the cell of the first base station 710-1 and may be connected to the first TRP 730-1. The cell of the first base station 710-1 may be a source cell (or serving cell). In addition, each of the cell of the second base station 710-2 or the cell of the third base station 710-3 may be a candidate cell around the source cell.

The terminal 740 may move from the source cell toward a neighbor cell, for example, toward the cell of the third base station 710-3. According to movement of the terminal 740, candidate cells for which LTM is performed may be the cell of the second base station 710-2 or the cell of the third base station 710-3. A CSI-RS set for the candidate cells may include at least one of CSI-RS 2, CSI-RS 3, CSI-RS 4, or CSI-RS 5. Here, CSI-RS 2 and CSI-RS 3 may be signals transmitted from the third TRP 730-3 or the fourth TRP 730-4 connected to the second DU 720-2 located in the cell of the second base station 710-2. CSI-RS 4 and CSI-RS 5 may be signals respectively transmitted from the fifth TRP 730-5 connected to the third DU 720-3 and the sixth TRP 730-6 connected to the fourth DU 720-4, which are located in the cell of the third base station 710-3.

The terminal 740 may receive, from the source cell (i.e. the first base station 710-1), a CSI-RS measurement indication for each of the candidate cells. The terminal 740 may perform measurement for all CSI-RSs of the candidate cells based on the received CSI-RS measurement indication. When the measurement result satisfies at least one of the four events described above, the terminal 740 may transmit a CSI-RS measurement report to the first base station 710-1.

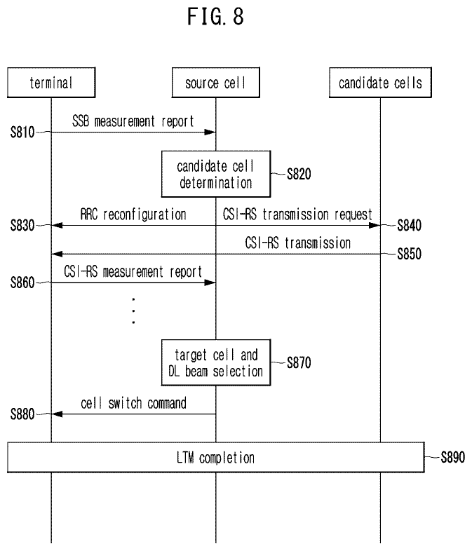

FIG. 8 is a sequence chart illustrating an exemplary embodiment of an LTM procedure for a terminal based on CSI-RS measurement.

Referring to FIG. 8, a terminal may measure Synchronization Signal Blocks (SSBs) of a source cell and cells around the source cell, and may transmit an SSB measurement report according to the measurement results to the source cell (S810). The source cell may refer to a cell in which the terminal is located or a base station of the cell. Cells around the source cell may refer to candidate cells to which the terminal may connect or base stations of the respective candidate cells. According to an exemplary embodiment, the terminal may transmit capability information to the source cell before transmitting the measurement report to the source cell.

The source cell may determine some of cells around the source cell as candidate cell(s) based on at least one of the SSB measurement report received from the terminal or the capability information of the terminal (S820).

The source cell may transmit an RRC reconfiguration message to the terminal (S830). The RRC reconfiguration message may include information on a list of CSI-RSs to be measured by the terminal or CSI-RS information of each of the candidate cell(s). The CSI-RS information of the candidate cell(s) may include at least one of PCI, SSB index, CSI-RS index, scheduling information, scrambling ID, quasi-co-location (QCL) relationship information between CSI-RS and SSB, or TCI state ID.

The source cell may request CSI-RS transmission from each of the candidate cell(s) (S840). Each of the candidate cell(s) may transmit CSI-RS to the terminal based on the CSI-RS transmission request received from the source cell (S850).

The terminal may receive a plurality of CSI-RSs from the candidate cell(s) and may transmit a measurement report to the source cell based on a result of measuring the received plurality of CSI-RSs (S860). The terminal may measure each of the plurality of CSI-RSs that are continuously received from the candidate cell(s) and, when the measurement results correspond to at least one of the events described in Table 1, the terminal may transmit a measurement report to the source cell.

The source cell may select one among the candidate cell(s) as a target cell based on the measurement report received from the terminal and may select a DL beam of the target cell (S870). The source cell may transmit, to the terminal, a cell switch command including information on the selected target cell and/or the DL beam (S880). The terminal may perform handover, for example, cell switching, from the source cell to the target cell based on the cell switch command received from the source cell. The terminal or the source cell may complete the LTM procedure of the terminal when cell switching is completed (S890).

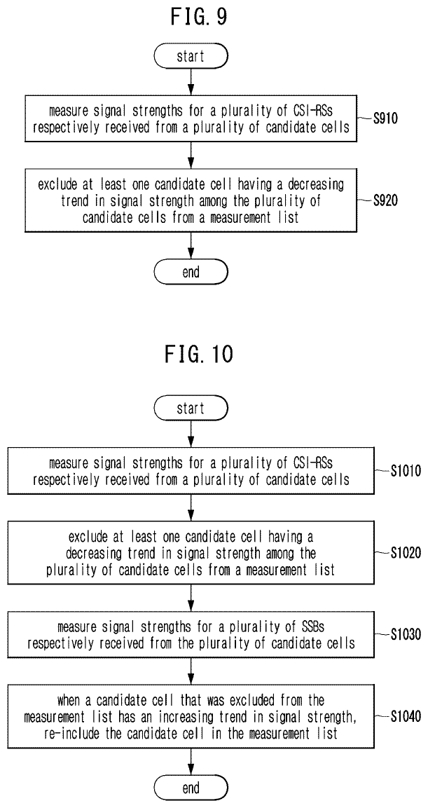

FIG. 9 is a flowchart illustrating an exemplary embodiment of changing a CSI-RS measurement list at a terminal.

Referring to FIG. 9, a terminal may measure a signal strength of each of a plurality of CSI-RSs respectively transmitted from a plurality of candidate cells (S910). As illustrated in FIG. 7, the terminal may be located in a source cell, for example, in the cell of the first base station 710-1, and a plurality of candidate cells, for example, the cell of the second base station 710-2 and the cell of the third base station 710-3, may be located around the source cell. The terminal may receive an RRC reconfiguration message from the source cell and, based on the RRC reconfiguration message, may receive a plurality of CSI-RSs that are continuously transmitted from the plurality of candidate cells.

Here, information on a measurement target list of the RRC reconfiguration message may include a list of a plurality of CSI-RSs defined as signals to be measured for signal strength measurement at the terminal. The terminal may measure a signal strength of each of the plurality of CSI-RSs corresponding to the measurement target list.

The terminal may select, among the plurality of CSI-RSs, at least one CSI-RS showing a decreasing trend in signal strength based on the measurement result and may exclude the selected CSI-RS from the measurement target list (S920).

Referring to FIG. 7, the terminal may move from the source cell to the cell of the third base station 710-3. As the terminal moves to the cell of the third base station 710-3, the terminal may detect that a signal strength of CSI-RSs continuously received from the cell of the second base station 710-2 becomes weaker. The terminal may exclude, from the measurement target list, the CSI-RS transmitted from the cell of the second base station 710-2.

For example, the terminal may exclude, from the measurement target list, the CSI-RS transmitted from the cell of the second base station 710-2 when, during a Time-To-Trigger (TTT), a CSI-RS whose reception power is smaller than a preset threshold is measured from the cell of the second base station 710-2 N or more times, or when it is determined that signal strengths of CSI-RSs transmitted from the cell of the second base station 710-2 have a negative slope.

FIG. 10 is a flowchart illustrating an exemplary embodiment of changing a CSI-RS measurement list at a terminal.

Referring to FIG. 10, a terminal may receive an RRC reconfiguration message from a source cell and, based on the RRC reconfiguration message, may periodically receive a plurality of SSBs from a plurality of candidate cells. The terminal may receive an SSB from each of the plurality of candidate cells before CSI-RS reception.

The terminal may measure a signal strength of each of a plurality of SSBs that have QCL relationships with a plurality of CSI-RSs defined in a measurement target list of the RRC reconfiguration message among the received plurality of SSBs (S1010).

The terminal may select, among the plurality of SSBs, at least one SSB showing a decreasing trend in signal strength based on the measurement result, and may exclude a CSI-RS associated with the selected SSB from the measurement target list (S1020).

For example, when a reception power of an SSB transmitted from at least one candidate cell among the plurality of candidate cells decreases as the terminal moves, a reception power of a CSI-RS having a QCL relationship with the SSB may also decrease. Therefore, the terminal may exclude, from the measurement target list, the CSI-RS transmitted from the candidate cell based on a result of measuring the reception power of the SSB.

After excluding at least one candidate cell among the plurality of candidate cells from the CSI-RS measurement target list, the terminal may receive SSBs from the plurality of candidate cells including the candidate cell excluded from the measurement list. The terminal may again measure signal strengths for the SSBs of the plurality of candidate cells (S1030).

When an SSB transmitted from at least one candidate cell that was excluded from the measurement target list at a previous time shows an increasing trend in signal strength based on the measurement result, the terminal may re-include the CSI-RS of the at least one candidate cell in the measurement target list (S1040).

As described above, in this exemplary embodiment, the terminal may exclude a CSI-RS of a specific candidate cell from the measurement target list or may re-include a CSI-RS of the candidate cell excluded from the measurement target list at a previous time into the measurement target list based on a result of measuring reception power of SSBs periodically transmitted from the plurality of candidate cells. However, in the method of changing the measurement list described with reference to FIG. 9, it may be difficult for the terminal to re-include the CSI-RS of the candidate cell excluded from the measurement target list at the previous time back into the measurement target list. However, when a CSI-RS reception power measurement periodicity of the terminal is shorter than an SSB reception periodicity, the terminal may quickly determine whether to exclude a CSI-RS of a specific candidate cell from the measurement target list and, accordingly, the terminal may reduce power consumption.

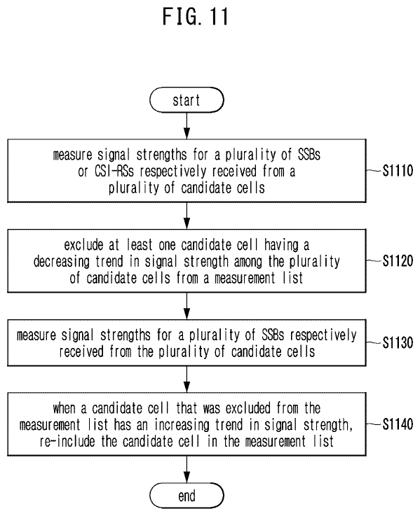

FIG. 11 is a flowchart illustrating an exemplary embodiment of changing a CSI-RS measurement list at a terminal.

Referring to FIG. 11, a terminal may receive a plurality of SSBs and a plurality of CSI-RSs from a plurality of candidate cells. The terminal may measure a signal strength for each of the plurality of SSBs and the plurality of CSI-RSs of the plurality of candidate cells based on a measurement target list of an RRC reconfiguration message (S1110).

The terminal may select, among the plurality of candidate cells, at least one candidate cell in which at least one of an SSB reception power or a CSI-RS reception power shows a decreasing trend based on the measurement result, and may exclude a CSI-RS transmitted from the selected candidate cell from the measurement target list (S1120).

After excluding a CSI-RS of at least one candidate cell among the plurality of candidate cells from the measurement target list, the terminal may receive SSBs from the plurality of candidate cells including the candidate cell excluded from the measurement target list. The terminal may again measure signal strengths for the SSBs of the plurality of candidate cells (S1130).

When an SSB transmitted from at least one candidate cell that was excluded from the measurement target list at a previous time shows an increasing trend in signal strength based on the measurement result, the terminal may re-include the CSI-RS of the at least one candidate cell in the measurement target list (S1140).

As described with reference to FIGS. 9 to 11, the terminal may exclude, from the measurement target list, a CSI-RS transmitted from at least one candidate cell in which a reception power of SSBs or CSI-RSs shows a decreasing trend based on measurement results of SSBs or CSI-RSs that are continuously received from the plurality of candidate cells. Accordingly, the terminal may reduce a number of measurements for CSI-RSs and may prevent overhead from occurring.

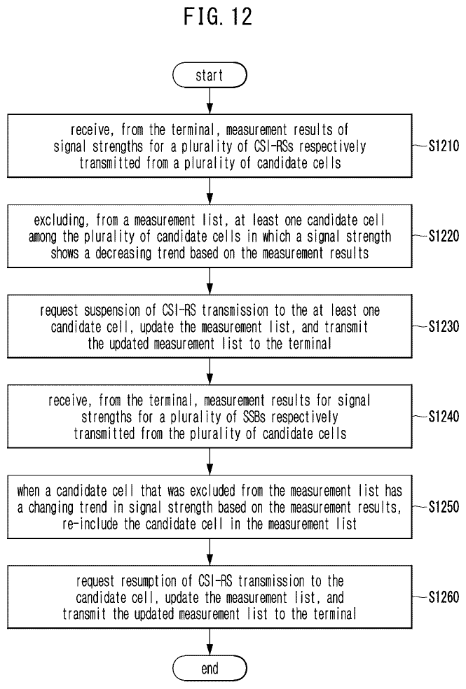

FIG. 12 is a flowchart illustrating an exemplary embodiment of changing a CSI-RS measurement list at a base station.

Referring to FIG. 12, a terminal may receive a plurality of CSI-RSs from a plurality of candidate cells and may measure a signal strength of each of the plurality of CSI-RSs. A source cell may receive the measurement result of each of the plurality of CSI-RSs transmitted from the terminal (S1210).

The source cell may select, among the plurality of candidate cells, at least one candidate cell in which a CSI-RS reception power shows a decreasing trend based on the received measurement result, and may exclude the CSI-RS of the selected candidate cell from the measurement target list (S1220).

The source cell may request suspension of CSI-RS transmission to the candidate cell excluded from the measurement target list. The candidate cell that receives the CSI-RS transmission suspension request from the source cell may not transmit CSI-RS to the terminal. In addition, the source cell may update the measurement target list and may transmit the updated measurement target list to the terminal (S1230). The terminal may stop measuring the CSI-RS of the candidate cell excluded from the measurement target list based on the updated measurement list received from the source cell.

The terminal may receive a plurality of SSBs from the plurality of candidate cells and may measure a signal strength of each of the plurality of SSBs. The terminal may receive the plurality of SSBs from the plurality of candidate cells including the candidate cell excluded from the CSI-RS measurement target list at a previous time. The source cell may receive the measurement result of each of the plurality of SSBs transmitted from the terminal (S1240).

When a reception power of an SSB transmitted from the candidate cell excluded from the measurement target list shows an increasing trend based on the measurement result received from the terminal, the source cell may re-include the CSI-RS of the candidate cell in the measurement target list (S1250).

The source cell may request resumption of CSI-RS transmission to the candidate cell re-included in the measurement target list. The candidate cell that receives the CSI-RS transmission resumption request from the source cell may transmit CSI-RS to the terminal. In addition, the source cell may update the measurement target list and may transmit the updated measurement target list to the terminal (S1260). The terminal may resume measuring CSI-RS of the re-included candidate cell based on the updated measurement target list received from the source cell.

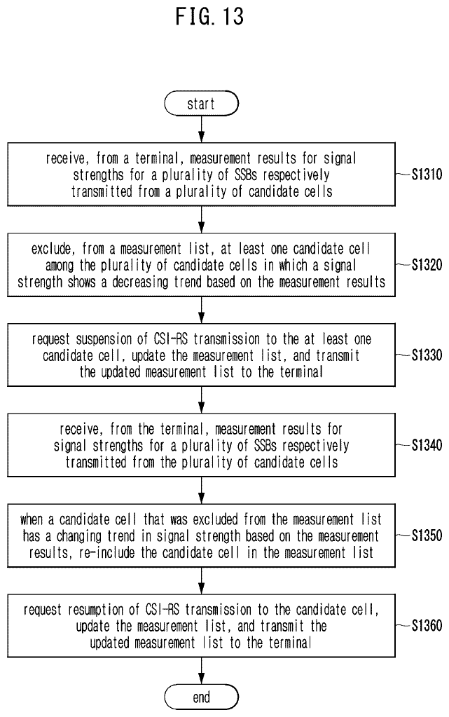

FIG. 13 is a flowchart illustrating an exemplary embodiment of changing a CSI-RS measurement list at a base station.

Referring to FIG. 13, a terminal may receive a plurality of SSBs from a plurality of candidate cells and may measure a signal strength of each of the plurality of SSBs. The source cell may receive the measurement result of each of the plurality of SSBs transmitted from the terminal (S1310).

The source cell may select, among the plurality of candidate cells, at least one candidate cell in which an SSB reception power shows a decreasing trend based on the received measurement result, and may exclude a CSI-RS of the selected candidate cell from the measurement target list (S1320). As described above, an SSB transmitted from one candidate cell may have a QCL relationship with each of a plurality of CSI-RSs transmitted from the candidate cell. Therefore, when a reception power of the SSB of the candidate cell decreases, a reception power of the CSI-RS of the candidate cell may also decrease.

The source cell may request suspension of CSI-RS transmission to the candidate cell excluded from the measurement target list. The source cell may update the measurement target list and may transmit the updated measurement target list to the terminal (S1330).

The terminal may receive a plurality of SSBs from the plurality of candidate cells including the candidate cell excluded from the measurement target list at a previous time. The source cell may receive from the terminal the measurement result of each of the plurality of SSBs (S1340).

When a reception power of an SSB transmitted from the candidate cell excluded from the measurement target list shows an increasing trend based on the measurement result received from the terminal, the source cell may re-include the CSI-RS of the candidate cell in the measurement target list (S1350).

The source cell may request resumption of CSI-RS transmission to the candidate cell re-included in the measurement target list. The source cell may update the measurement target list and may transmit the updated measurement list to the terminal (S1360).

As described above, the source cell may request suspension of CSI-RS transmission to at least one candidate cell among the plurality of candidate cells based on the signal strength measurement result received from the terminal and may transmit the updated measurement target list to the terminal. Therefore, the terminal may reduce power consumption for CSI-RS measurement, and the candidate cell excluded from the measurement target list may prevent consumption of radio resources for transmitting CSI-RS to the terminal.

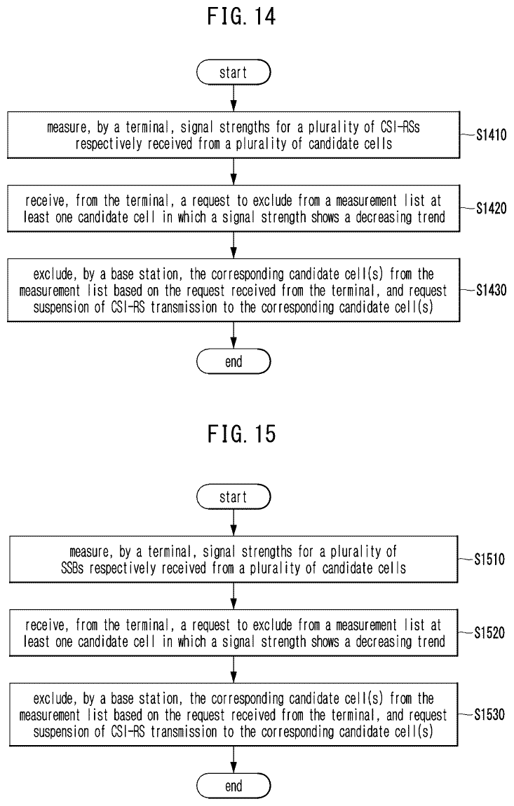

FIG. 14 is a flowchart illustrating an exemplary embodiment of changing a CSI-RS measurement list at a terminal and a base station.

Referring to FIG. 14, a terminal may respectively receive a plurality of CSI-RSs from a plurality of candidate cells and may measure a signal strength of each of the plurality of CSI-RSs (S1410). The terminal may select at least one candidate cell showing a decreasing trend in CSI-RS signal strength among the plurality of candidate cells based on the measurement result.

The terminal may transmit a CSI-RS measurement exclusion request to a source cell based on the selected at least one candidate cell. The source cell may receive the CSI-RS measurement exclusion request for the at least one candidate cell from the terminal (S1420).

The source cell may exclude the CSI-RS(s) of the corresponding candidate cell(s) from a stored measurement target list based on the received measurement exclusion request. The source cell may request the candidate cell(s) excluded from the measurement target list among the plurality of candidate cells to stop CSI-RS transmission (S1430). The candidate cell(s) that receive the CSI-RS transmission stop request from the source cell may stop transmitting CSI-RS to the terminal.

FIG. 15 is a flowchart illustrating an exemplary embodiment of changing a CSI-RS measurement list at a terminal and a base station.

Referring to FIG. 15, a terminal may respectively receive a plurality of SSBs from a plurality of candidate cells and may measure a signal strength of each of the plurality of SSBs (S1510). The terminal may select at least one candidate cell showing a decreasing trend in SSB signal strength among the plurality of candidate cells based on the measurement result.

The terminal may transmit a CSI-RS measurement exclusion request to a source cell based on the selected at least one candidate cell. The source cell may receive the CSI-RS measurement exclusion request for the at least one candidate cell from the terminal (S1520).

The source cell may exclude the CSI-RS(s) of the corresponding candidate cell(s) from a stored measurement target list based on the received measurement exclusion request. The source cell may request the candidate cell(s) excluded from the measurement target list among the plurality of candidate cells to stop CSI-RS transmission (S1530). The candidate cell(s) that receive the CSI-RS transmission stop request from the source cell may stop transmitting CSI-RS to the terminal.

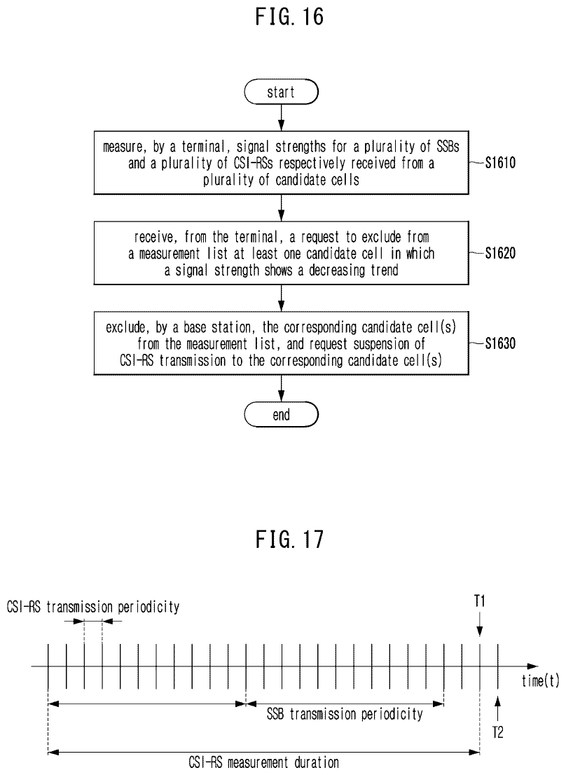

FIG. 16 is a flowchart illustrating an exemplary embodiment of changing a CSI-RS measurement list at a terminal and a base station.

Referring to FIG. 16, a terminal may receive a plurality of SSBs and a plurality of CSI-RSs from a plurality of candidate cells. The terminal may measure a signal strength of each of the plurality of SSBs and the plurality of CSI-RSs for the plurality of candidate cells (S1610).

The terminal may select at least one candidate cell showing a decreasing trend in SSB or CSI-RS reception strength among the plurality of candidate cells based on the measurement result.

The terminal may transmit a CSI-RS measurement exclusion request to a source cell based on the selected at least one candidate cell. The source cell may receive the CSI-RS measurement exclusion request from the terminal (S1620).

The source cell may exclude the CSI-RS(s) of the corresponding candidate cell(s) from a measurement target list based on the received measurement exclusion request. The source cell may request the candidate cell(s) excluded from the measurement target list among the plurality of candidate cells to stop CSI-RS transmission (S1630). The candidate cell(s) that receive the CSI-RS transmission stop request from the source cell may stop transmitting CSI-RS to the terminal.

As described above, the terminal may transmit a measurement list exclusion request for at least one candidate cell to the source cell based on the measurement result of signals transmitted from the plurality of candidate cells. Accordingly, since the source cell may request CSI-RS transmission stop to the corresponding candidate cell(s) based on the measurement list exclusion request received from the terminal, consumption of radio resources of the source cell may be reduced.

FIG. 17 is a conceptual diagram illustrating an exemplary embodiment of changing a CSI-RS measurement list at a terminal or a base station.

Referring to FIG. 17, a plurality of candidate cells may periodically transmit SSBs and CSI-RSs to a terminal. A transmission periodicity of CSI-RS may be a value between 4 and 640 slots and may be relatively shorter than a transmission periodicity of SSB.

The terminal may measure a signal strength (e.g. reception strength) for each of a plurality of CSI-RSs continuously transmitted respectively from the plurality of candidate cells. The terminal may select at least one candidate cell to be excluded from a CSI-RS measurement target list among the plurality of candidate cells at a time T1 based on the measurement result. The terminal may transmit at least one of the measurement result of the plurality of CSI-RSs or a measurement exclusion request for the at least one candidate cell to a source cell. The source cell may request at least one of the plurality of candidate cells to stop CSI-RS transmission based on at least one of the measurement result of the plurality of CSI-RSs or the measurement exclusion request received from the terminal. The at least one candidate cell may stop transmitting CSI-RS to the terminal at a time T2.

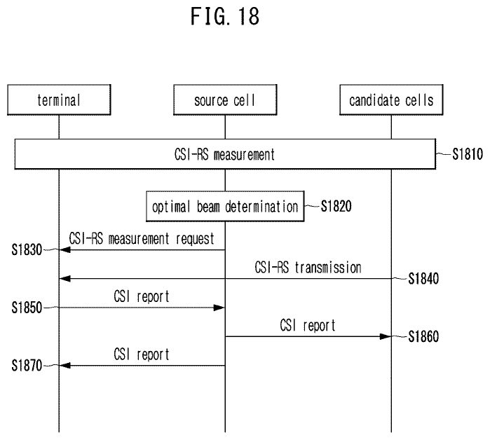

FIG. 18 is a sequence chart illustrating an exemplary embodiment of acquiring CSI before cell switching of a terminal.

Referring to FIG. 18, a terminal may measure CSI-RSs of a source cell or cells around the source cell, for example, each of a plurality of candidate cells. The terminal may transmit the measurement result to the source cell (S1810).

The source cell may determine an optimal beam based on the CSI-RS measurement result received from the terminal (S1820). For example, the source cell may determine, as an optimal beam, a beam corresponding to one CSI-RS having the largest signal strength, that is, the largest signal reception strength at the terminal, among a plurality of CSI-RSs transmitted to the terminal from the plurality of candidate cells based on the CSI-RS measurement result.

The source cell may transmit a CSI measurement request to the terminal (S1830). The CSI measurement request may include at least one of a CSI-RS activation indication, a CSI-RS resource set, or a signal transmission scheme for the terminal.

The source cell may request a cell, for example, a target cell, which transmits a CSI-RS corresponding to the optimal beam determined among the plurality of candidate cells, to transmit CSI-RS. The target cell may transmit at least one CSI-RS for CSI measurement of the terminal to the terminal based on the CSI-RS transmission request received from the source cell (S1840).

The terminal may measure at least one CSI-RS received from the target cell and may transmit a CSI report including CSI to the source cell based on the measurement result (S1850). The source cell may transmit the CSI report received from the terminal to the target cell (S1860).

Here, the CSI may include extensive channel information and may include at least one among a channel quality indicator (CQI), a precoding matrix indicator (PMI), or a rank indicator (RI). Therefore, in order for the target cell to acquire the aforementioned CSI, the target cell may transmit a CSI-RS having a form widely distributed in the frequency or time domain to the terminal as compared with a CSI-RS transmitted to the terminal for existing beam management, for example, for optimal beam selection of the source cell.

The source cell may transmit a cell switch command to the terminal based on the CSI report received from the terminal (S1870). The terminal may perform cell switching from the source cell to the target cell based on the cell switch command.

The cell switch command may include a TCI state ID of the CSI-RS for the optimal beam. The terminal may receive data through a DL signal (or a DL beam) corresponding to the optimal beam from the target cell based on the cell switch command. Here, a base station of the target cell may determine an MCS of the DL signal based on the CSI report received from the source cell. Therefore, since the target cell is able to transmit data to the terminal at a high data transmission rate, the quality of service before and after the cell switching of the terminal may be maintained equally.

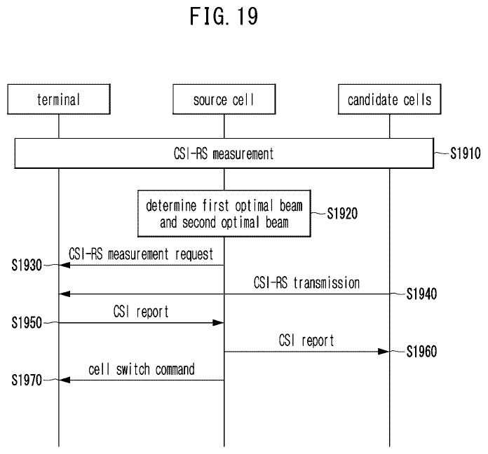

FIG. 19 is a sequence chart illustrating an exemplary embodiment of acquiring CSI before cell switching of a terminal.

Referring to FIG. 19, a terminal may measure CSI-RSs of a source cell or cells around the source cell, for example, each of a plurality of candidate cells. The terminal may transmit a measurement result to the source cell (S1910).

The source cell may determine a first optimal beam and a second optimal beam respectively based on the CSI-RS measurement result received from the terminal (S1920). For example, the source cell may determine, as the first optimal beam, a beam corresponding to one CSI-RS signal having the largest signal strength among a plurality of CSI-RSs transmitted to the terminal from the plurality of candidate cells based on the CSI-RS measurement result, and may determine, as the second optimal beam, a beam corresponding to one CSI-RS having the largest signal strength excluding the first optimal beam.

The source cell may transmit a CSI measurement request to the terminal (S1930). The CSI measurement request may include at least one of a CSI-RS activation indication, a CSI-RS resource set for CSI measurement, or a signal transmission scheme for the terminal.

The source cell may request at least one target cell that transmits CSI-RSs corresponding to the first optimal beam and the second optimal beam determined among the plurality of candidate cells to transmit CSI-RS. According to an exemplary embodiment, CSI-RSs respectively corresponding to the first optimal beam and the second optimal beam may be transmitted from the same target cell or may be transmitted from different target cells. The target cell may transmit at least one CSI-RS for CSI measurement of the terminal to the terminal based on the CSI-RS transmission request received from the source cell (S1940).

The terminal may measure at least one CSI-RS received from the target cell(s) and may transmit a CSI report including CSI to the source cell based on the measurement result (S1950). The source cell may transmit the CSI report received from the terminal to the target cell(s) (S1960). Here, the CSI may include at least one among CQI, PMI, or RI.

The source cell may transmit a cell switch command to the terminal based on the CSI report received from the terminal (S1970). The terminal may perform cell switching from the source cell to the target cell based on the cell switch command.

The cell switch command may include a TCI state ID of the CSI-RS for the first optimal beam. The terminal may receive data through a DL signal corresponding to the first optimal beam from the target cell based on the cell switch command. Here, since a base station of the target cell may determine an MCS of the DL signal based on the CSI report received from the source cell, the target cell may transmit data to the terminal at a high data transmission rate. In addition, when a channel change occurs, the target cell may transmit data to the terminal through a DL signal corresponding to the second optimal beam based on the CSI report received from the source cell.

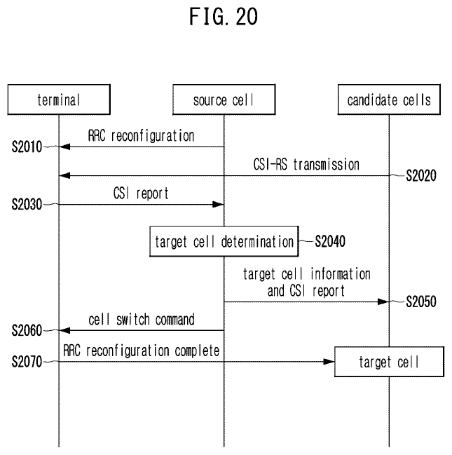

FIG. 20 is a sequence chart illustrating an exemplary embodiment of acquiring CSI before cell switching of a terminal.

Referring to FIG. 20, a source cell may transmit an RRC reconfiguration message to a terminal (S2010). The RRC reconfiguration message may include at least one of a CSI-RS activation indication, a CSI-RS resource set for CSI measurement, or a signal transmission scheme for the terminal. The signal transmission scheme information may include information indicating a periodic, semi-persistent, or aperiodic transmission scheme of CSI-RS.

The terminal may be triggered so that CSI measurement is activated based on the RRC reconfiguration message received from the source cell. For example, when the RRC reconfiguration message includes semi-persistent signal transmission scheme information, the CSI measurement may be triggered based on an SP CSI-RS resource set activation MAC CE. In addition, when the RRC reconfiguration message includes aperiodic signal transmission scheme information, the CSI measurement may be triggered based on a PDCCH or DCI.

The source cell may request each of a plurality of candidate cells to transmit CSI-RS for CSI measurement of the terminal. The plurality of candidate cells may transmit a plurality of CSI-RSs to the terminal (S2020).

The terminal may measure the plurality of CSI-RSs received from the plurality of candidate cells and may transmit a CSI report including CSI to the source cell based on the measurement result (S2030).

The source cell may determine one cell among the plurality of candidate cells as a target cell based on the CSI report received from the terminal (S2040). The source cell may transmit information on the target cell and the CSI report to the target cell (S2050). The source cell may transmit information on the target cell to a network, for example, to each of the plurality of candidate cells.

The terminal may receive a cell switch command from the source cell (S2060). Based on the received cell switch command, the terminal may perform cell switching by releasing a connection with the source cell and attempting to establish a connection with the target cell. When the cell switching is completed, the terminal may transmit an RRC reconfiguration complete message to the target cell to report the completion of the cell switching (S2070).

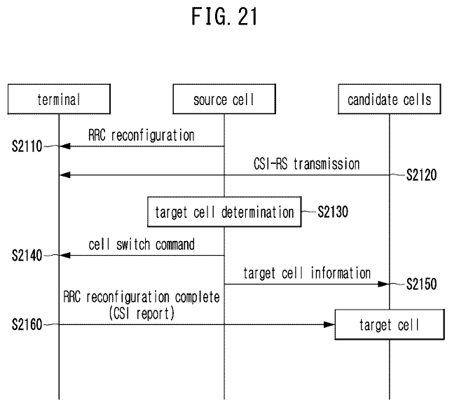

FIG. 21 is a sequence chart illustrating an exemplary embodiment of acquiring CSI during cell switching of a terminal.

Referring to FIG. 21, a source cell may transmit an RRC reconfiguration message to a terminal (S2110). The RRC reconfiguration message may include at least one of a CSI-RS activation indication, a CSI-RS resource set for CSI measurement, or a signal transmission scheme for the terminal.

The source cell may request each of a plurality of candidate cells to transmit a CSI-RS for CSI measurement of the terminal. The plurality of candidate cells may transmit a plurality of CSI-RSs to the terminal (S2120).

The source cell may determine one cell among the plurality of candidate cells as a target cell (S2130). The source cell may transmit a cell switch command to the terminal (S2140). In addition, the source cell may transmit information on the target cell to a network, for example, to each of the plurality of candidate cells (S2150).

Based on the cell switch command received from the source cell, the terminal may perform cell switching by releasing a connection with the source cell and attempting to establish a connection with the target cell. When the cell switching is completed, the terminal may transmit an RRC reconfiguration complete message to the target cell to report the completion of the cell switching (S2160).

The terminal may transmit a CSI report including CSI to the target cell by including it in the RRC reconfiguration complete message. The target cell may determine an MCS of a DL signal based on the CSI report included in the RRC reconfiguration complete message. Therefore, the target cell may transmit data to the terminal at a high data transmission rate, thereby preventing degradation of quality of a data service provided to the terminal.

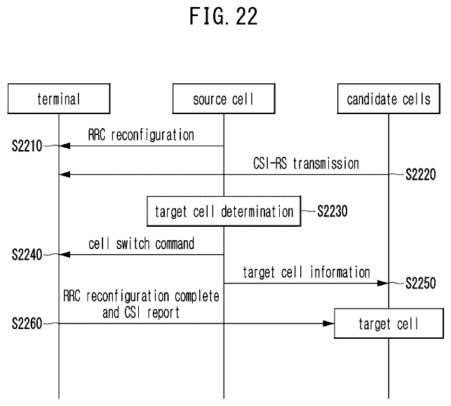

FIG. 22 is a sequence chart illustrating an exemplary embodiment of acquiring CSI during cell switching of a terminal.

Referring to FIG. 22, a source cell may transmit an RRC reconfiguration message to a terminal (S2210). The RRC reconfiguration message may include at least one of a CSI-RS resource set or a signal transmission scheme for CSI measurement for the terminal.

The source cell may request each of a plurality of candidate cells to transmit a CSI-RS for CSI measurement of the terminal. The plurality of candidate cells may transmit a plurality of CSI-RSs to the terminal (S2220).

The source cell may determine one cell among the plurality of candidate cells as a target cell (S2230). The source cell may transmit a cell switch command to the terminal (S2240). In addition, the source cell may transmit information on the target cell to a network, for example, to each of the plurality of candidate cells (S2250).

Based on the cell switch command received from the source cell, the terminal may perform cell switching by releasing a connection with the source cell and attempting to establish a connection with the target cell. When the cell switching is completed, the terminal may transmit an RRC reconfiguration complete message to the target cell to report the completion of the cell switching (S2260).

The terminal may transmit a CSI report including CSI to the target cell together with the RRC reconfiguration complete message. The terminal may allocate the RRC reconfiguration complete message to a physical uplink shared channel (PUSCH) and may allocate the CSI report to an uplink control indicator (UCI) control channel. The terminal may multiplex the RRC reconfiguration complete message and the CSI report respectively allocated to the PUSCH and the UCI control channel, and may transmit them to the target cell. In other words, the terminal may multiplex and transmit the RRC reconfiguration complete message and the CSI report in one channel, for example, the PUSCH.

The target cell may decode, at a physical layer, a transport block including the CSI report in the signal received from the terminal and may deliver the RRC reconfiguration complete message to a higher layer. Therefore, the target cell may quickly determine an MCS of a DL signal based on the CSI report decoded at the physical layer, and thus may maintain the same quality of service before and after cell switching of the terminal.

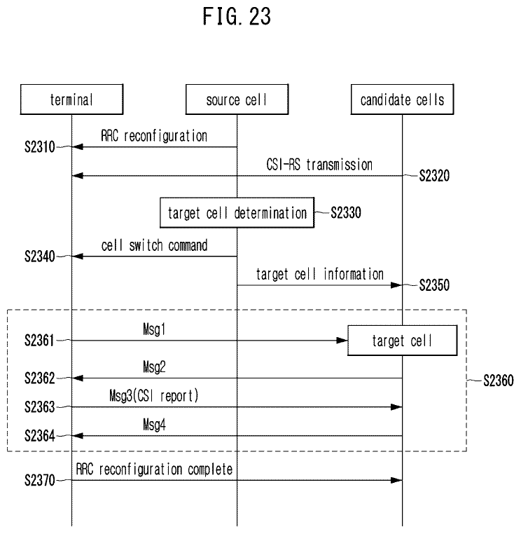

FIG. 23 is a sequence chart illustrating an exemplary embodiment of acquiring CSI during cell switching of a terminal.

Referring to FIG. 23, a source cell may transmit an RRC reconfiguration message to a terminal (S2310). The RRC reconfiguration message may include at least one of a CSI-RS resource set or a signal transmission scheme for CSI measurement for the terminal.

The source cell may request each of a plurality of candidate cells to transmit a CSI-RS for CSI measurement of the terminal. The plurality of candidate cells may transmit a plurality of CSI-RSs to the terminal (S2320).

The source cell may determine one cell among the plurality of candidate cells as a target cell (S2330). The source cell may transmit a cell switch command to the terminal (S2340). In addition, the source cell may transmit information on a target cell to a network, for example, to each of the plurality of candidate cells (S2350).

Based on a cell switch command received from the source cell, the terminal may release a connection with the source cell and may perform a random access procedure for cell switching to the target cell (S2360). The random access procedure between the terminal and the target cell may be the same as an existing random access procedure except that a CSI report is included in one message transmitted to the target cell. For example, the terminal may transmit Msg1 including a preamble for random access to the target cell (S2361). The target cell may receive the preamble from the terminal and may transmit a random access response (RAR), for example, Msg2, to the terminal (S2362). The terminal may perform UL synchronization based on Msg2 received from the target cell. The terminal may multiplex a CSI report including CSI into a first PUSCH (e.g. Msg3 (e.g. RRC connection request message)) transmitted to the target cell using an uplink grant included in Msg2 (S2363). The target cell may determine an MCS of a DL signal based on the CSI report received from the terminal. The target cell may transmit Msg4, for example, an RRC connection complete message, to the terminal by using the DL signal (S2364). When the random access procedure between the terminal and the target cell is completed, the terminal may transmit an RRC reconfiguration complete message to the target cell (S2370).

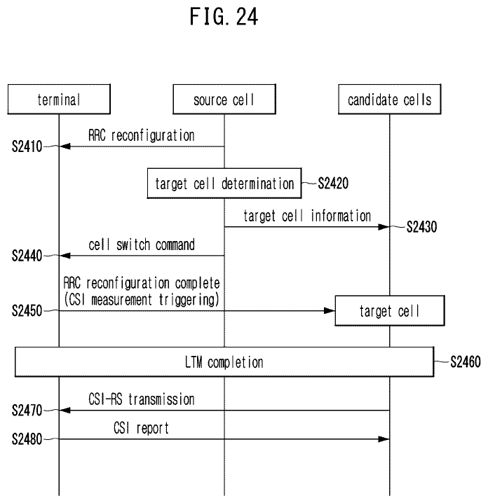

FIG. 24 is a sequence chart illustrating an exemplary embodiment of acquiring CSI after cell switching of a terminal.

Referring to FIG. 24, a source cell may transmit an RRC reconfiguration message to a terminal (S2410). The RRC reconfiguration message may include at least one of a CSI-RS resource set for CSI measurement or a signal transmission scheme for the terminal. The source cell may request each of a plurality of candidate cells to transmit a CSI-RS for CSI measurement of the terminal. The plurality of candidate cells may transmit a plurality of CSI-RSs to the terminal.

The source cell may determine one cell among the plurality of candidate cells as a target cell (S2420). The source cell may transmit a cell switch command to the terminal (S2440). In addition, the source cell may transmit information on a target cell to a network, for example, to each of the plurality of candidate cells (S2430).

Based on the cell switch command received from the source cell, the terminal may perform cell switching by releasing a connection with the source cell and attempting to establish a connection with the target cell. When the cell switching is completed, the terminal may transmit an RRC reconfiguration complete message to the target cell (S2450). The terminal may complete the LTM procedure based on transmission of the RRC reconfiguration complete message (S2450).

The terminal may include CSI measurement triggering information in the RRC reconfiguration complete message and may transmit the RRC reconfiguration complete message to the target cell. The target cell may transmit at least one CSI-RS to the terminal after completion of the LTM procedure of the terminal based on the CSI measurement triggering information received from the terminal (S2470).

The terminal may measure a CSI-RS received from the target cell and may transmit a CSI report including CSI to the target cell according to the measurement result (S2480). Therefore, the target cell may acquire up-to-date CSI from the terminal after completion of the cell switching of the terminal. In addition, by performing measurement for the CSI-RS transmitted from the target cell, the terminal may reduce complexity of CSI measurement of the terminal.

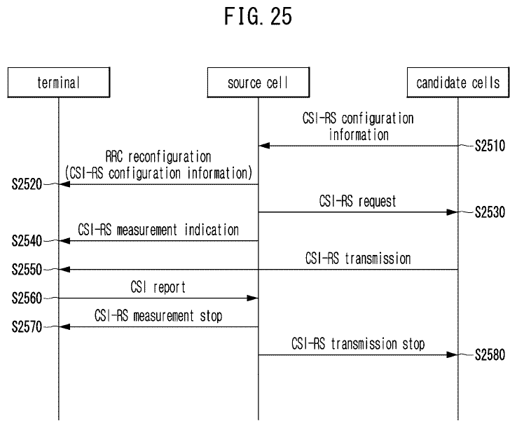

FIG. 25 is a sequence chart illustrating an exemplary embodiment of a CSI-RS downlink transmission scheme.

Referring to FIG. 25, a source cell may receive a message including CSI-RS configuration information from each of a plurality of candidate cells (S2510). The CSI-RS configuration information may include information on a CSI-RS transmission scheme of each of the plurality of candidate cells, for example, information on a semi-persistent transmission scheme.

The source cell may transmit an RRC reconfiguration message including the received CSI-RS configuration information to the terminal (S2520). The RRC reconfiguration message may include at least one of the aforementioned CSI-RS transmission scheme information, CSI report configuration information, or scheduling information. In addition, the source cell may request each of the plurality of candidate cells to transmit CSI-RS (S2530).

The source cell may transmit a CSI measurement indication to the terminal (S2540). For example, since each of the plurality of candidate cells transmits CSI-RS in the semi-persistent transmission scheme, the source cell may transmit an SP CSI-RS resource set activation MAC-CE to the terminal to trigger activation of CSI measurement of the terminal. Here, the source cell may identify CSI-RS transmission availability from at least one of the plurality of candidate cells based on the CSI-RS transmission request transmitted to each of the plurality of candidate cells. The source cell may transmit the CSI measurement indication to the terminal based on a result of identifying CSI-RS transmission availability of each of the plurality of candidate cells.

The terminal may respectively receive a plurality of CSI-RSs from the plurality of candidate cells (S2550). The terminal may measure each of the plurality of CSI-RSs received and may transmit a CSI report including CSI to the source cell based on the measurement result (S2560).

The source cell may request the terminal to stop CSI-RS measurement based on the CSI report received from the terminal (S2570). For example, the source cell may transmit an SP CSI-RS resource set deactivation MAC-CE to the terminal to trigger deactivation of CSI measurement of the terminal. In addition, the source cell may request each of the plurality of candidate cells to stop CSI-RS transmission based on the CSI report (S2580). Here, after the source cell transmits the CSI-RS measurement stop request to the terminal, the source cell may request each of the plurality of candidate cells to stop CSI-RS transmission. Therefore, the terminal may prevent consumption of radio resources for CSI-RS measurement and may reduce CSI-RS measurement errors.

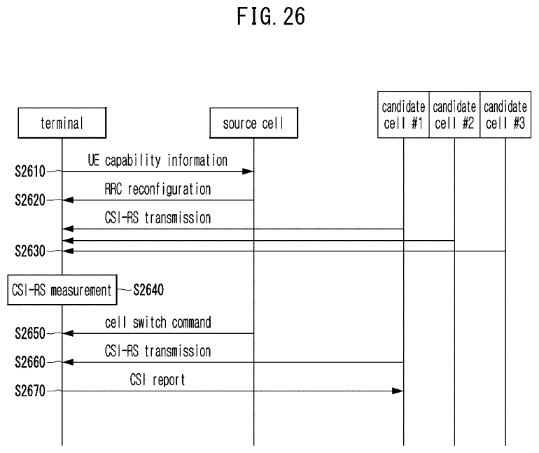

FIG. 26 is a sequence chart illustrating an exemplary embodiment of measuring CSI before a terminal receives a cell switch command.

Referring to FIG. 26, a terminal may be RRC-connected to a source cell and may transmit UE capability information to the source cell (S2610). For example, the terminal may transmit UE capability information including at least one of LTM support, support for early CSI measurement before reception of a cell switch command, a number of CSI-RS resource sets in which CSI measurement is possible, support for a CSI-RS transmission scheme in which CSI measurement is possible, or support for a transmission scheme for a CSI report to the source cell. Since early CSI measurement is possible before reception of a cell switch command, the terminal may transmit UE capability information including capability for the early CSI measurement to the source cell.

The source cell may transmit an RRC reconfiguration message to the terminal based on the capability information received from the terminal (S2620). The RRC reconfiguration message may include at least one of a CSI-RS resource set for CSI measurement or CSI-RS configuration information for the terminal. The CSI-RS configuration information may include configuration information of the CSI-RS resource set, and the configuration information may include at least one among a transmission scheme, a periodicity, an offset, frequency/time mapping, port allocation, or scrambling information of the CSI-RS resource set.

The source cell may request each of a plurality of candidate cells, for example, a first candidate cell, a second candidate cell, and a third candidate cell, to transmit CSI-RS based on the capability information received from the terminal. Each of the plurality of candidate cells may transmit CSI-RS to the terminal based on the CSI-RS transmission request of the source cell (S2630).

Each of the plurality of candidate cells may transmit CSI-RS to the terminal through a periodic transmission scheme. The terminal may measure each of the plurality of CSI-RSs transmitted from the plurality of candidate cells and may acquire CSI based on the measurement result (S2640).

The source cell may determine one cell among the plurality of candidate cells, for example, the first candidate cell, as a target cell. The source cell may transmit a cell switch command including information on the target to the terminal (S2650). The terminal may release a connection with the source cell and perform cell switching to the target cell based on the cell switch command received from the source cell.

The source cell may request the remaining candidate cells excluding the target cell among the plurality of candidate cells to stop CSI-RS transmission. The terminal may receive a CSI-RS from the target cell (S2660) and may acquire CSI based on the measurement result of the received CSI-RS. The terminal may update existing CSI by using the CSI and may transmit a CSI report including the CSI to the target cell (S2670). For example, the terminal may include the CSI report in an RRC reconfiguration complete message and may transmit the RRC reconfiguration complete message to the target cell, or the terminal may multiplex the RRC reconfiguration complete message and the CSI report and may transmit the multiplexed message to the target cell.

Meanwhile, the terminal may acquire CSI for the target cell before reception of the cell switch command from the source cell. In this case, after the terminal receives the cell switch command, the terminal may not receive a CSI-RS from the target cell, or the terminal may not update the existing CSI by using CSI acquired from the CSI-RS of the target cell. In addition, after the terminal receives the cell switch command, the terminal may receive a CSI-RS from the target cell, and the terminal may update the existing CSI by using CSI acquired from the CSI-RS. The terminal may determine whether to update the CSI based on the cell switch command received from the source cell. The source cell may allow the terminal to determine whether to perform updating of the CSI by explicitly adding a CSI measurement indicator field to the cell switch command or by transmitting an RRC message. Alternatively, the source cell may allow the terminal to determine whether to perform updating of the CSI implicitly when the terminal receives the cell switch command.

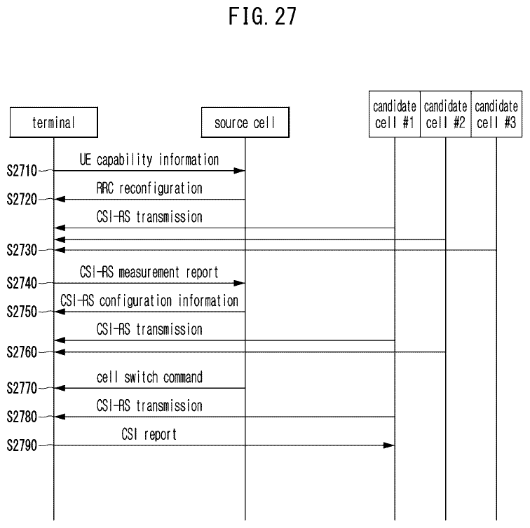

FIG. 27 is a sequence chart illustrating an exemplary embodiment of measuring CSI before a terminal receives a cell switch command.

Referring to FIG. 27, a terminal may be RRC-connected to a source cell and may transmit UE capability information to the source cell (S2710). The UE capability information may include at least one of LTM support, support for early CSI-RS measurement before reception of a cell switch command, a number of CSI-RS resource sets in which CSI measurement is possible, support for a CSI-RS transmission scheme in which CSI measurement is possible, or support for a transmission scheme for a CSI report. Since early CSI measurement is possible before reception of a cell switch command, the terminal may transmit the UE capability information including the capability for the early CSI measurement to the source cell.

The source cell may transmit an RRC reconfiguration message to the terminal based on the capability information received from the terminal (S2720). The RRC reconfiguration message may include at least one among a CSI-RS resource set for CSI measurement or CSI-RS configuration information for the terminal.

The source cell may request each of a plurality of candidate cells to transmit CSI-RS based on the capability information received from the terminal. Each of the plurality of candidate cells may transmit CSI-RS to the terminal based on the CSI-RS transmission request of the source cell (S2730).

The terminal may measure a signal strength, for example, L1-RSRP, of each of a plurality of CSI-RSs transmitted from the plurality of candidate cells and may transmit the measurement result to the source cell (S2740).

The source cell may determine a target cell candidate group, for example, a first candidate cell and a second candidate cell, which may be determined as a target cell among the plurality of candidate cells based on the measurement result received from the terminal. The source cell may transmit CSI-RS configuration information for the determined target cell candidate group to the terminal (S2750). The CSI-RS configuration information may include a CSI-RS activation indication for the target cell candidate group. The source cell may transmit the CSI-RS configuration information to the terminal by using at least one among an RRC configuration message, DCI, or MAC CE.

The source cell may request each of the target cell candidate group, that is, the first candidate cell and the second candidate cell, to transmit CSI-RS. Each of the first candidate cell and the second candidate cell may transmit CSI-RS to the terminal based on the CSI-RS transmission request of the source cell (S2760).

The terminal may receive the CSI-RS from each of the first candidate cell and the second candidate cell based on the CSI-RS activation indication of the CSI-RS configuration information. The terminal may measure the received CSI-RSs for CSI and may update existing CSI based on the measurement result.

The source cell may determine the first candidate cell of the target cell candidate group as a target cell. The source cell may transmit a cell switch command including information on the target cell to the terminal (S2770). Based on the cell switch command received from the source cell, the terminal may release a connection with the source cell and may perform cell switching to the target cell. In addition, the terminal may stop CSI updating or may measure CSI for a CSI-RS of the target cell based on the cell switch command. Here, the terminal may stop CSI updating or may measure the CSI for the CSI-RS of the target cell based on a CSI measurement indicator field included in the cell switch command. In addition, the terminal may implicitly stop CSI updating or may measure CSI for the CSI-RS of the target cell based on the cell switch command.

The source cell may request the remaining candidate cells excluding the target cell among the plurality of candidate cells to stop CSI-RS transmission. The terminal may receive a CSI-RS from the target cell (S2780) and may acquire CSI based on the measurement result of the received CSI-RS. The terminal may update existing CSI by using the CSI and may transmit a CSI report for the CSI measurement result to the target cell (S2790).

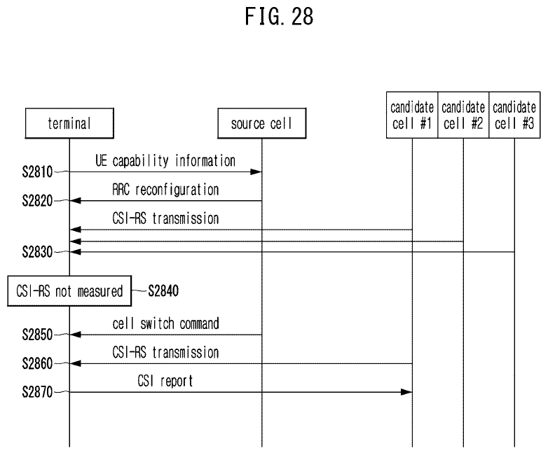

FIG. 28 is a sequence chart illustrating an exemplary embodiment of measuring CSI after a terminal receives a cell switch command.

Referring to FIG. 28, a terminal may be RRC-connected to a source cell and may transmit UE capability information to the source cell (S2810). The UE capability information may include at least one of LTM support, support for CSI-RS measurement after reception of a cell switch command, a number of CSI-RS resource sets in which CSI measurement is possible, support for a CSI-RS transmission scheme in which CSI measurement is possible, or support for a transmission scheme for a CSI report. Since CSI measurement is possible after reception of a cell switch command, the terminal may transmit the UE capability information including the capability for the CSI measurement to the source cell.

The source cell may transmit an RRC reconfiguration message to the terminal based on the capability information received from the terminal (S2820). The RRC reconfiguration message may include at least one among a CSI-RS resource set for CSI measurement or CSI-RS configuration information for the terminal.

The source cell may request each of a plurality of candidate cells to transmit CSI-RS based on the capability information received from the terminal. Each of the plurality of candidate cells may transmit CSI-RS to the terminal based on the CSI-RS transmission request of the source cell (S2830).

As described above, since CSI measurement is possible after reception of a cell switch command, the terminal may not receive each of a plurality of CSI-RSs from the plurality of candidate cells, or even when the terminal receives the plurality of CSI-RSs, the terminal may not perform signal strength measurement of the CSI-RSs (S2840).

The source cell may determine one cell among the plurality of candidate cells, for example, a first candidate cell, as a target cell. The source cell may transmit a cell switch command including information on the target cell to the terminal (S2850). Based on the cell switch command received from the source cell, the terminal may release a connection with the source cell and may perform cell switching to the target cell.

The source cell may request the remaining candidate cells excluding the target cell among the plurality of candidate cells to stop CSI-RS transmission. The terminal may receive a CSI-RS from the target cell (S2860), may activate the CSI-RS of the target cell based on the cell switch command, may measure the CSI-RS, and may acquire CSI. The terminal may update existing CSI by using the CSI and may transmit a CSI report for the CSI measurement result to the target cell (S2870). The terminal may include the CSI report in an RRC reconfiguration complete message and may transmit the RRC reconfiguration complete message to the target cell, or the terminal may multiplex the RRC reconfiguration complete message and the CSI report and may transmit them to the target cell.

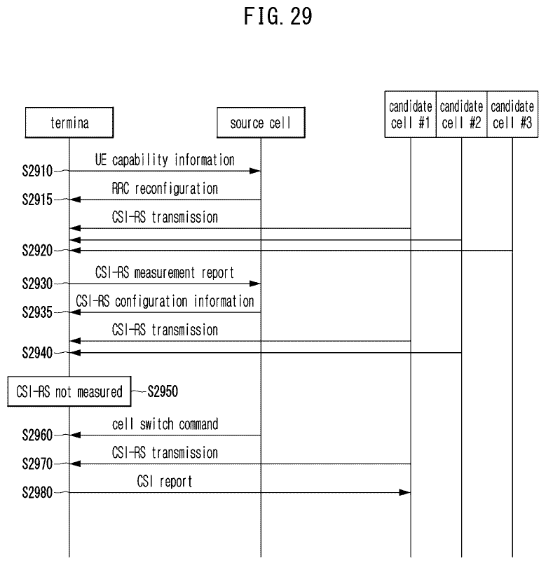

FIG. 29 is a sequence chart illustrating an exemplary embodiment of measuring CSI after a terminal receives a cell switch command.

Referring to FIG. 29, a terminal may be RRC-connected to a source cell and may transmit UE capability information to the source cell (S2910). The UE capability information may include at least one of LTM support, support for CSI-RS measurement after reception of a cell switch command, a number of CSI-RS resource sets in which CSI measurement is possible, support for a CSI-RS transmission scheme in which CSI measurement is possible, or support for a transmission scheme for a CSI report. Since CSI measurement is possible after reception of a cell switch command, the terminal may transmit the UE capability information including the capability for the CSI measurement to the source cell.

The source cell may transmit an RRC reconfiguration message to the terminal based on the capability information received from the terminal (S2915). The RRC reconfiguration message may include at least one among a CSI-RS resource set for CSI measurement or CSI-RS configuration information for the terminal.

The source cell may request each of a plurality of candidate cells to transmit CSI-RS based on the capability information received from the terminal. Each of the plurality of candidate cells may transmit CSI-RS to the terminal based on the CSI-RS transmission request of the source cell (S2920).

The terminal may measure a signal strength, for example, L1-RSRP, of each of a plurality of CSI-RSs transmitted from the plurality of candidate cells and may transmit the measurement result to the source cell (S2930).

The source cell may determine a target cell candidate group, for example, a first candidate cell and a second candidate cell, which may be determined as a target cell among the plurality of candidate cells based on the measurement result received from the terminal. The source cell may transmit CSI-RS configuration information for the determined target cell candidate group to the terminal (S2935). The CSI-RS configuration information may include a CSI-RS activation indication for the target cell candidate group. The source cell may transmit the CSI-RS configuration information to the terminal by using at least one of an RRC configuration message, DCI, or MAC CE.

The source cell may request each of the target cell candidate group, that is, the first candidate cell and the second candidate cell, to transmit CSI-RS. Each of the first candidate cell and the second candidate cell may transmit CSI-RS to the terminal based on the CSI-RS transmission request of the source cell (S2940).

The terminal may receive the CSI-RSs transmitted from the target cell candidate group based on the CSI-RS activation indication of the CSI-RS configuration information. Here, since CSI measurement is possible after reception of a cell switch command, the terminal may not perform CSI measurement for the CSI-RS transmitted from the target cell candidate group (S2950).

The source cell may determine the first candidate cell as a target cell from the target cell candidate group. The source cell may transmit a cell switch command including information on the target cell to the terminal (S2960). Based on the cell switch command received from the source cell, the terminal may release a connection with the source cell and may perform cell switching to the target cell.

The source cell may request the remaining candidate cells excluding the target cell among the plurality of candidate cells to stop CSI-RS transmission. The terminal may receive a CSI-RS from the target cell (S2970) and may measure the CSI-RS of the target cell based on the cell switch command to acquire CSI. The terminal may update existing CSI by using the CSI and may transmit a CSI report including the CSI to the target cell (S2980). Here, the terminal may determine the cell switch command as a trigger for CSI-RS measurement or CSI reporting and may perform CSI-RS measurement of the target cell and CSI reporting according to the measurement result based on the cell switch command.

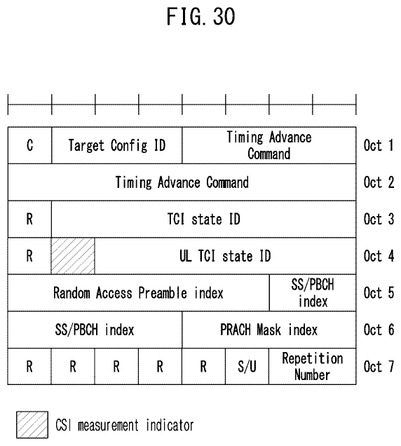

FIG. 30 is a conceptual diagram illustrating an exemplary embodiment of a cell switch command format including a field for requesting CSI measurement of a terminal.

Referring to FIG. 30, a source cell may transmit a cell switch command explicitly indicating a CSI measurement indication to a terminal. As described above with reference to FIG. 6, the cell switch command may be in a MAC CE format and may include a MAC payload composed of a plurality of fields. The plurality of fields of the MAC payload may include at least one among a C field, R fields, a target configuration ID field, a TAC field, a TCI state ID field, an uplink TCI state ID field, an RA preamble index field, an SS/PBCH index field, a PRACH mask index field, an S/U field, or a repetition number field.

A CSI measurement indicator field indicating the CSI measurement indication may be represented by using an R field among the plurality of fields of the cell switch command. Therefore, an overall size of the cell switch command may not be increased.

The CSI measurement indicator field may function as a trigger for activation or deactivation of CSI measurement of the terminal. For example, when a value of the CSI measurement indicator field is 0, the terminal may perform CSI measurement by receiving a CSI-RS from the target cell after receiving the cell switch command. In addition, when a value of the CSI measurement indicator field is 1, the terminal may not receive a CSI-RS from the target cell after receiving the cell switch command or may not perform CSI measurement.

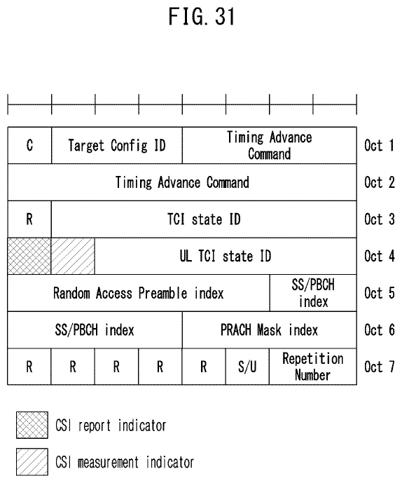

FIG. 31 is a conceptual diagram illustrating an exemplary embodiment of a cell switch command format including a field for requesting CSI measurement reporting of a terminal.

Referring to FIG. 31, a source cell may transmit a cell switch command explicitly indicating a CSI measurement indication and a CSI report indication to a terminal. As described above, the cell switch command may be in a MAC CE format and may include a plurality of fields. A CSI measurement indicator field indicating the CSI measurement indication and a CSI report indicator field indicating the CSI report indication may be represented by using R fields among the plurality of fields of the cell switch command. Therefore, an overall size of the cell switch command may not be increased.

The CSI measurement indicator field may function as a trigger for activation or deactivation of CSI measurement of the terminal. In addition, the CSI report indicator field may function as a trigger for activation or deactivation of CSI reporting of the terminal. For example, when a value of the CSI measurement indicator field is 0, the terminal may perform CSI measurement by receiving a CSI-RS from the target cell after receiving the cell switch command. In addition, when a value of the CSI measurement indicator field is 1, the terminal may not receive a CSI-RS from the target cell after receiving the cell switch command or may not perform CSI measurement. When a value of the CSI report indicator field is 0, the terminal may transmit a CSI report to the target cell after receiving the cell switch command. In addition, when a value of the CSI report indicator field is 1, the terminal may not transmit a CSI report to the target cell after receiving the cell switch command.

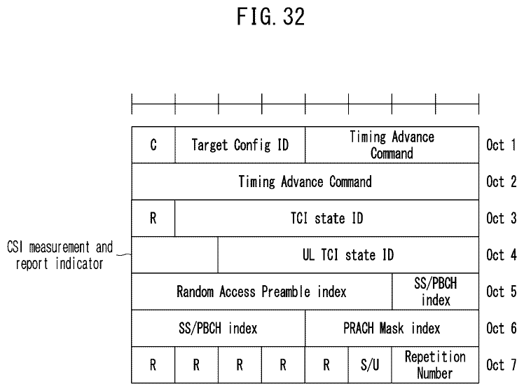

FIG. 32 is a conceptual diagram illustrating an exemplary embodiment of a cell switch command format including a field for requesting CSI measurement and reporting of a terminal.

Referring to FIG. 32, a source cell may transmit a cell switch command explicitly indicating a CSI measurement indication and a CSI report indication to the terminal. The cell switch command may be in a MAC CE format and may include a plurality of fields. A field indicating the CSI measurement indication and a field indicating the CSI report indication may be combined into two R fields, for example, a two-bit field among the plurality of fields of the cell switch command, and may be represented as a CSI measurement and report indicator field.

The CSI measurement and report indicator field may indicate four types of terminal operations. For example, when a value of the CSI measurement and report indicator field is ‘00,’ the terminal may not perform both CSI measurement and CSI reporting. When a value of the CSI measurement and report indicator field is ‘01,’ the terminal may perform only CSI reporting. When a value of the CSI measurement and report indicator field is ‘10,’ the terminal may perform only CSI measurement. In addition, when a value of the CSI measurement and report indicator field is ‘11,’ the terminal may perform both CSI measurement and CSI reporting.

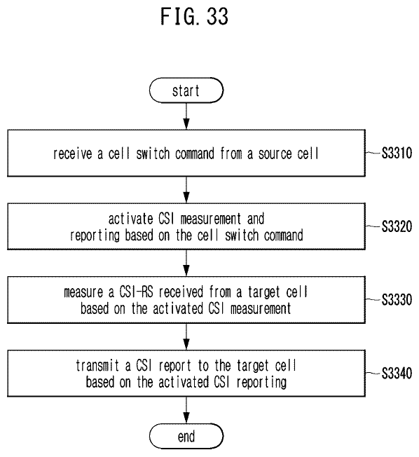

FIG. 33 is a flowchart illustrating an exemplary embodiment of measuring and reporting CSI based on reception of a cell switch command of a terminal.

Referring to FIG. 33, a terminal may be RRC-connected to a source cell and may transmit UE capability information to the source cell. Since CSI measurement is possible after reception of a cell switch command, the terminal may transmit the UE capability information including the capability for CSI measurement to the source cell.

The terminal may receive a cell switch command from the source cell (S3310). The terminal may activate CSI measurement and CSI reporting based on the received cell switch command (S3320). The terminal may determine the cell switch command as a trigger for CSI measurement and CSI reporting. The terminal may receive CSI-RS configuration information of each of a plurality of candidate cells through an RRC reconfiguration message from the source cell before receiving the cell switch command. The terminal may activate CSI measurement and CSI reporting according to the previously received CSI-RS configuration information based on the cell switch command.

For example, when the CSI-RS configuration information for CSI measurement configures a semi-persistent scheme, the cell switch command may activate CSI-RS transmission of the target cell instead of an SP CSI-RS activation/deactivation MAC CE. When the CSI-RS configuration information for CSI reporting configures a semi-persistent scheme, the cell switch command may activate uplink resources to the target cell instead of an SP CSI reporting activation MAC CE. In addition, when the CSI-RS configuration information for CSI reporting configures a periodic scheme and a type-2 configured grant (CG) for uplink resources is set as inactive, the cell switch command may activate the uplink resources to the target cell instead of DCI activating the CG.

The terminal may perform measurement of a CSI-RS received from the target cell based on the CSI measurement activated by the cell switch command (S3330). The terminal may transmit a CSI report corresponding to the CSI-RS measurement to the target cell based on the CSI reporting activated by the cell switch command (S3340).

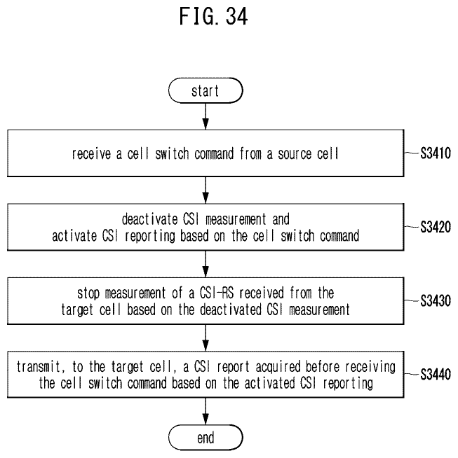

FIG. 34 is a flowchart illustrating an exemplary embodiment of measuring and reporting CSI based on reception of a cell switch command of a terminal.

Referring to FIG. 34, a terminal may be RRC-connected to a source cell and may transmit UE capability information to the source cell. Since CSI measurement is possible after reception of a cell switch command, the terminal may transmit the UE capability information including the capability for CSI measurement to the source cell.

The terminal may receive a cell switch command from the source cell (S3410). The terminal may deactivate CSI measurement and may activate CSI reporting based on the received cell switch command (S3420). The terminal may determine the cell switch command as a trigger for CSI measurement and CSI reporting. The terminal may receive CSI-RS configuration information of each of a plurality of candidate cells through an RRC reconfiguration message from the source cell before receiving the cell switch command. The terminal may deactivate CSI measurement and may activate CSI reporting according to the previously received CSI-RS configuration information based on the cell switch command.

The terminal may stop measurement of a CSI-RS received from the target cell based on the CSI measurement deactivated by the cell switch command (S3430). The terminal may transmit a CSI report corresponding to the CSI-RS measurement to the target cell based on the CSI reporting activated by the cell switch command (S3440).

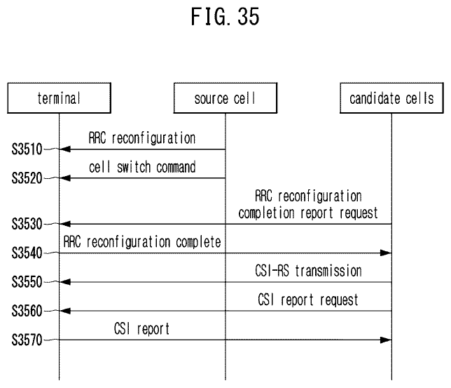

FIG. 35 is a sequence chart illustrating an exemplary embodiment of dynamic-grant-based CSI reporting of a terminal.

Referring to FIG. 35, a source cell may transmit, to a terminal, an RRC reconfiguration message including CSI-RS configuration information of each of a plurality of candidate cells (S3510). The CSI-RS configuration information may include at least one of a CSI-RS resource configuration for CSI measurement of the terminal or a CSI report configuration of the terminal. In the exemplary embodiment, a time domain of the CSI report configuration of the terminal may be configured as aperiodic. Therefore, uplink resources for CSI reporting of the terminal may be configured based on a dynamic grant scheme.

The source cell may determine one among the plurality of candidate cells as a target cell. The source cell may transmit information on the target cell to the plurality of candidate cells. In addition, the source cell may transmit, to the terminal, a cell switch command including the information on the target cell (S3520). The information on the target cell may include a cell ID, a TCI state, beam information, and the like. The terminal may apply the CSI measurement configuration and the CSI report configuration from the CSI-RS configuration information of each of the plurality of candidate cells previously received, based on the cell switch command.

The target cell may request, from the terminal, reporting of completion of the RRC reconfiguration (S3530). The target cell may schedule an uplink resource to the terminal through DCI (e.g. DCI 0_1), and the terminal may transmit, to the target cell, an RRC reconfiguration complete message through the scheduled uplink resource (S3540). For example, the target cell may configure a CSI request field of the DCI to a value of 0 and may transmit the DCI to the terminal. The terminal may transmit, to the target cell, an RRC reconfiguration complete message not including a CSI report based on the DCI received from the target cell.

The target cell may transmit, to the terminal, CSI-RS based on the RRC reconfiguration complete message received from the terminal (S3550). The terminal may measure the CSI-RS received from the target cell and may acquire CSI (e.g. CSI values).

The target cell may request, from the terminal, CSI reporting (S3560). The target cell may schedule an uplink resource to the terminal through DCI, and the terminal may transmit, to the target cell, a CSI report through the scheduled uplink resource (S3570). For example, the target cell may configure a CSI request field of the DCI to a value of 1 and may transmit the DCI to the terminal. The terminal may transmit, to the target cell, the CSI report based on the DCI received from the target cell.

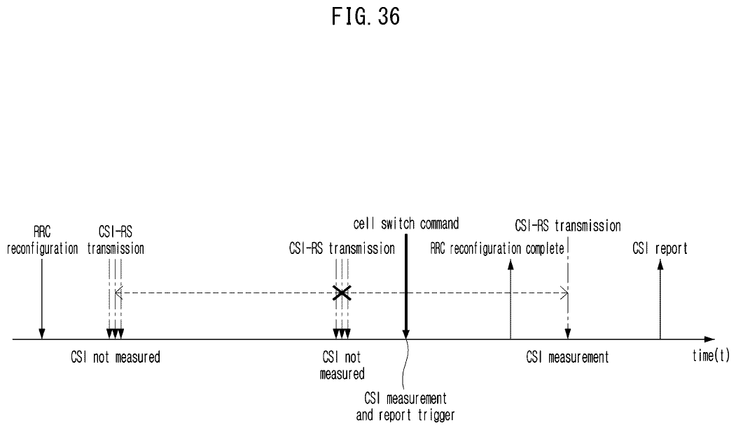

FIG. 36 is a conceptual diagram illustrating an exemplary embodiment of a timeline of CSI reporting of a terminal.

Referring to FIG. 36, a source cell may transmit, to the terminal, CSI-RS configuration information for each of a plurality of candidate cells through an RRC reconfiguration message. The CSI-RS configuration information may include at least one of a CSI-RS resource configuration for CSI measurement or a CSI report configuration for the terminal.

The plurality of candidate cells may periodically transmit, to the terminal, a plurality of CSI-RSs based on a CSI-RS transmission request of the source cell. The terminal may be a terminal having a capability to perform CSI measurement and reporting after receiving a cell switch command from the source cell. Therefore, the terminal may not receive the plurality of CSI-RSs from the plurality of candidate cells or may not perform measurement of the received CSI-RSs before receiving a cell switch command from the source cell.

The source cell may transmit, to the terminal, a cell switch command. The terminal may determine the received cell switch command as a trigger for activation of CSI measurement and reporting. The terminal may activate CSI measurement and CSI reporting according to the CSI-RS configuration information received through the RRC reconfiguration message based on the cell switch command.

The source cell may determine a target cell among the plurality of candidate cells. The target cell may transmit, to the terminal, a CSI-RS. The terminal may measure the CSI-RS received from the target cell and may transmit, to the target cell, a CSI report including CSI according to the measurement result. The terminal may transmit, to the target cell, the CSI report through an uplink resource allocated from the target cell. The target cell may allocate, to the terminal, the uplink resource periodically configured based on a configured grant, or may allocate the uplink resource based on a dynamic grant.

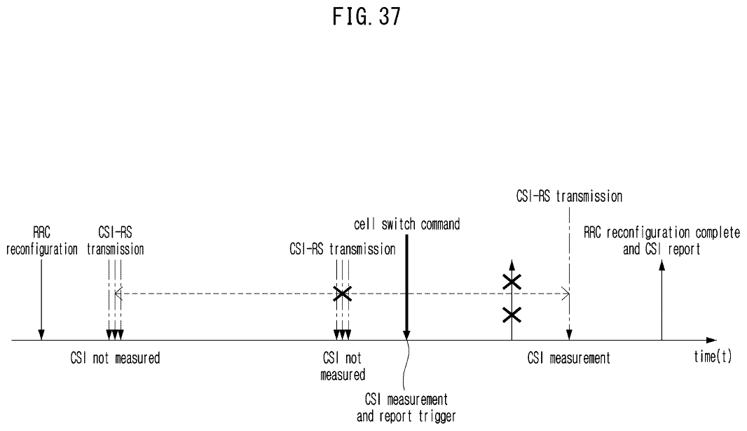

FIG. 37 is a conceptual diagram illustrating an exemplary embodiment of a timeline of CSI reporting of a terminal.

Referring to FIG. 37, a source cell may transmit, to a terminal, CSI-RS configuration information for each of a plurality of candidate cells through an RRC reconfiguration message. The CSI-RS configuration information may include at least one of a CSI-RS resource configuration for CSI measurement or a CSI report configuration for the terminal.

The plurality of candidate cells may periodically transmit, to the terminal, a plurality of CSI-RSs based on a CSI-RS transmission request of the source cell. The terminal may be a terminal having a capability to perform CSI measurement and reporting after receiving a cell switch command from the source cell. Therefore, the terminal may not receive the plurality of CSI-RSs from the plurality of candidate cells or may not perform measurement of the received CSI-RSs before receiving a cell switch command from the source cell.

The source cell may transmit, to the terminal, a cell switch command. The terminal may determine the received cell switch command as a trigger for activation of CSI measurement and reporting. The terminal may activate CSI measurement and CSI reporting according to the CSI-RS configuration information received through the RRC reconfiguration message based on the cell switch command.

The source cell may determine a target cell among the plurality of candidate cells. The target cell may transmit, to the terminal, a CSI-RS. The terminal may measure the CSI-RS received from the target cell and may transmit, to the target cell, a CSI report including CSI according to the measurement result. The terminal may transmit, to the target cell, an RRC reconfiguration complete message including the CSI report by using an uplink resource allocated from the target cell. In an exemplary embodiment, the terminal may multiplex the RRC reconfiguration complete message and the CSI report and may transmit, to the target cell, the multiplexed message by using the allocated uplink resource.

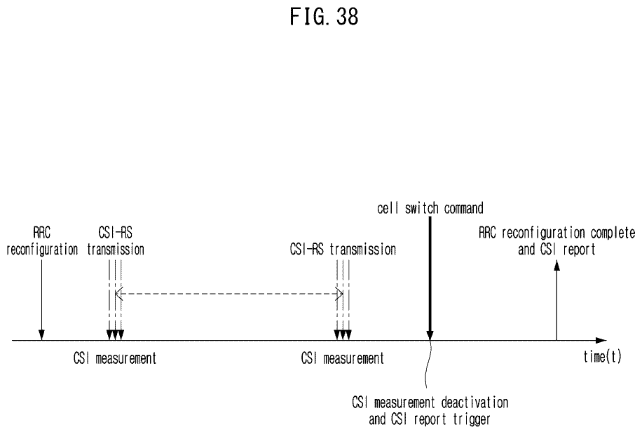

FIG. 38 is a conceptual diagram illustrating an exemplary embodiment of a timeline of CSI reporting of a terminal.

Referring to FIG. 38, a source cell may transmit, to a terminal, CSI-RS configuration information for each of a plurality of candidate cells through an RRC reconfiguration message. The CSI-RS configuration information may include at least one of a CSI-RS resource configuration for CSI measurement or a CSI report configuration for the terminal.

The plurality of candidate cells may periodically transmit, to the terminal, a plurality of CSI-RSs based on a CSI-RS transmission request of the source cell. The terminal may be a terminal having a capability to perform CSI measurement and reporting before receiving a cell switch command from the source cell. Therefore, the terminal may receive the plurality of CSI-RSs transmitted from each of the plurality of candidate cells and may measure the received plurality of CSI-RSs and may acquire CSI before receiving a cell switch command.

The source cell may transmit, to the terminal, a cell switch command. The terminal may determine the received cell switch command as a trigger for deactivation of CSI measurement and activation of CSI reporting. The terminal may stop measurement of the CSI-RS received from the target cell based on the CSI measurement deactivated by the cell switch command. The terminal may transmit, to the target cell, a CSI report based on the CSI reporting activated by the cell switch command. The terminal may multiplex an RRC reconfiguration complete message and the CSI report and may transmit, to the target cell, the multiplexed message by using an uplink resource allocated from the target cell.

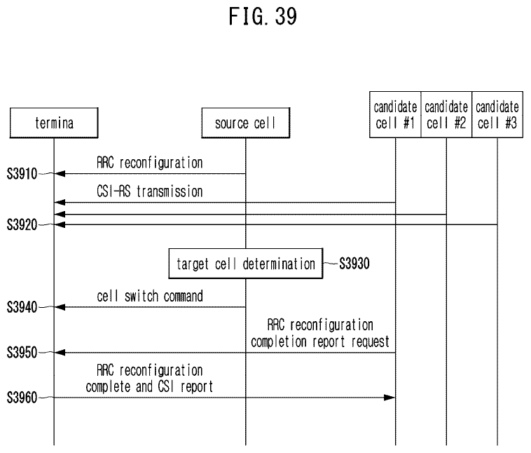

FIG. 39 is a sequence chart illustrating an exemplary embodiment of dynamic-grant-based CSI reporting of a terminal.

Referring to FIG. 39, a terminal may be RRC-connected to a source cell and may transmit UE capability information to the source cell. The source cell may transmit, to the terminal, an RRC reconfiguration message based on the UE capability information received from the terminal (S3910). The RRC reconfiguration message may include a CSI-RS resource set or CSI-RS configuration information of each of a plurality of candidate cells for CSI measurement of the terminal.

The source cell may request each of the plurality of candidate cells, for example, a first candidate cell through a third candidate cell to transmit CSI-RS. Each of the plurality of candidate cells may transmit, to the terminal, a CSI-RS based on the CSI-RS transmission request of the source cell (S3920). The terminal may receive each of the plurality of CSI-RSs received from the plurality of candidate cells and may measure each of the plurality of CSI-RSs and may acquire CSI (e.g. CSI values).

The source cell may determine one cell among the plurality of candidate cells, for example, the first candidate cell, as a target cell (S3930). The source cell may transmit, to the terminal, a cell switch command including information on the target cell (S3940).

The terminal may determine the cell switch command received from the source cell as a trigger for deactivation of CSI measurement and activation of CSI reporting. The terminal may stop measurement of a CSI-RS received from each of the plurality of candidate cells based on the CSI measurement deactivated by the cell switch command. In addition, the terminal may release a connection with the source cell and may perform cell switching to the target cell, based on the cell switch command.

The target cell may request, from the terminal, reporting of completion of the RRC reconfiguration (S3950). The target cell may transmit, to the terminal, DCI (e.g. DCI 0_1) including at least one field of an RRC reconfiguration completion report request or a CSI report request. Here, the target cell may recognize that the terminal has acquired CSI of the target cell. The target cell may configure a CSI request field of the DCI to a value of 1 and may transmit the DCI to the terminal.

The terminal may transmit, to the target cell, a CSI report including CSI previously acquired together with an RRC reconfiguration complete message based on the RRC reconfiguration completion report request received from the target cell (S3960). The terminal may multiplex the RRC reconfiguration complete message and the CSI report and may transmit, to the target cell, the multiplexed message by using an uplink resource allocated through the DCI. Here, the source cell may transmit, to the terminal, the RRC reconfiguration message including a multiplexing configuration for the RRC reconfiguration complete message and the CSI report. The source cell may transmit, to the target cell, the multiplexing configuration in the RRC reconfiguration message. Therefore, the target cell may previously recognize that the terminal multiplexes and transmits the RRC reconfiguration complete message and the CSI report.

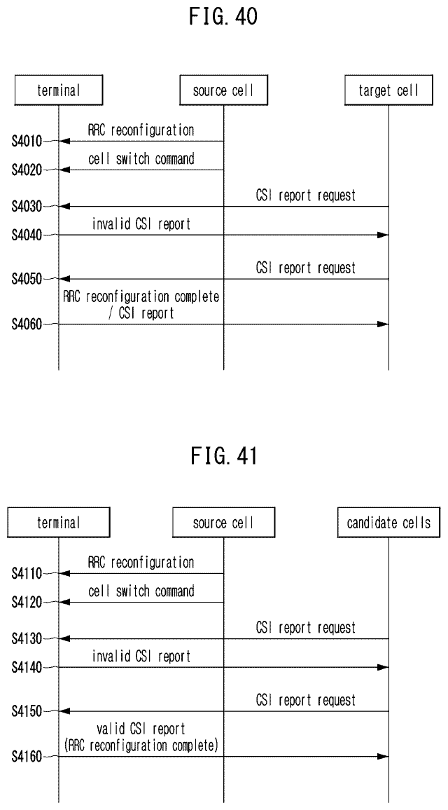

FIG. 40 is a sequence chart illustrating an exemplary embodiment of dynamic-grant-based multiplexed reporting of an RRC reconfiguration complete message and CSI by a terminal.

Referring to FIG. 40, a source cell may receive UE capability information from a terminal and may transmit, to the terminal, an RRC reconfiguration message based on the received UE capability information (S4010). The RRC reconfiguration message may include a multiplexing transmission configuration for a CSI report and an RRC reconfiguration complete message of the terminal. For example, the source cell may configure ‘CSI Multiplexing Enable’ to ‘on’ in the RRC reconfiguration message and may transmit the RRC reconfiguration message.

The source cell may transmit, to the terminal, a cell switch command including information on a target cell (S4020). Based on the cell switch command, the terminal may release a connection with the source cell and may perform cell switching to the target cell.

The target cell may request, from the terminal, CSI reporting (S4030). For example, the target cell may set a value of a CSI report request field of DCI to 1 and may transmit the DCI to the terminal. The terminal may receive the CSI report request from the target cell. In this case, when a CSI report is not prepared, the terminal may transmit, to the target cell, an invalid CSI report, or may transmit a signal indicating that a CSI report is not prepared (e.g. CSI not ready signal) (S4040).

The target cell may receive the invalid CSI report or the CSI not ready signal from the terminal. The target cell may re-request CSI reporting from the terminal (S4050). As described above, the target cell may set a value of a CSI report request field of DCI to 1 and may transmit the DCI to the terminal. When a CSI report is prepared, the terminal may transmit, to the target cell, a CSI report re-requested by the target cell. In this case, the terminal may multiplex an RRC reconfiguration complete message and the CSI report based on the multiplexing transmission configuration of the RRC reconfiguration message received from the source cell and may transmit the multiplexed message to the target cell (S4060).

FIG. 41 is a sequence chart illustrating an exemplary embodiment of dynamic-grant-based multiplexed reporting of an RRC reconfiguration complete message and CSI by a terminal.

Referring to FIG. 41, a source cell may receive UE capability information from a terminal and may transmit, to the terminal, an RRC reconfiguration message based on the received UE capability information (S4110). The RRC reconfiguration message may include a multiplexing transmission configuration for a CSI report and an RRC reconfiguration complete message of the terminal.

The source cell may transmit, to the terminal, a cell switch command including information on a target cell (S4120). Based on the cell switch command, the terminal may release a connection with the source cell and may perform cell switching to the target cell.

The target cell may request, from the terminal, CSI reporting (S4130). For example, the target cell may set a value of a CSI report request field of DCI to 1 and may transmit the DCI to the terminal. The terminal may receive the CSI report request from the target cell. In this case, when a CSI report is not prepared, the terminal may transmit, to the target cell, an invalid CSI report, or may transmit a signal indicating that a CSI report is not prepared (e.g. CSI not ready signal) (S4140)

The target cell may receive the invalid CSI report or the CSI not ready signal from the terminal. The target cell may re-request CSI reporting from the terminal (S4150). As described above, the target cell may set a value of a CSI report request field of DCI to 1 and may transmit the DCI to the terminal. When a CSI report is prepared, the terminal may transmit, to the target cell, a valid CSI report multiplexed with an RRC reconfiguration complete message based on the CSI reporting re-requested by the target cell (S4160).

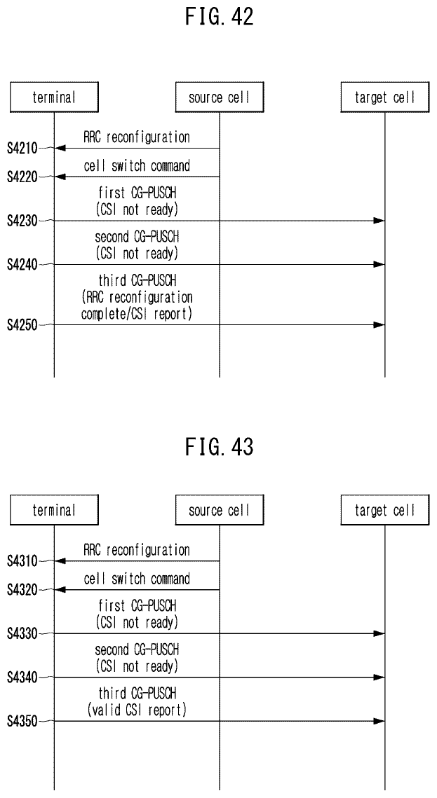

FIG. 42 is a sequence chart illustrating an exemplary embodiment of configured-grant-based multiplexed reporting of an RRC reconfiguration complete message and CSI by a terminal.

Referring to FIG. 42, a source cell may receive UE capability information from a terminal and may transmit, to the terminal, an RRC reconfiguration message based on the received UE capability information (S4210). The RRC reconfiguration message may include a multiplexing transmission configuration for a CSI report and an RRC reconfiguration complete message of the terminal. For example, the source cell may set ‘CSI Multiplexing Enable’ to ‘on’ in the RRC reconfiguration message and may transmit the RRC reconfiguration message.

The source cell may transmit, to the terminal, a cell switch command including information on a target cell (S4220). Based on the cell switch command, the terminal may release a connection with the source cell and may perform cell switching to the target cell.

The terminal may multiplex and transmit, to the target cell, an RRC reconfiguration complete message and a CSI report by using a configured-grant-based PUSCH (CG-PUSCH) periodically allocated. Here, when the CSI report is prepared, the terminal may transmit, to the target cell, the multiplexed message through the CG-PUSCH.

For example, a CSI report may not be prepared at a time when a first CG-PUSCH is allocated. The terminal may transmit, to the target cell, a signal indicating that a CSI report is not prepared (e.g. CSI not ready signal) or an invalid CSI report, through the first CG-PUSCH (S4230). In an exemplary embodiment, the terminal may not transmit any signal through the first CG-PUSCH. In addition, a CSI report may not be prepared at a time when a second CG-PUSCH is allocated. The terminal may transmit, to the target cell, a signal indicating that a CSI report is not prepared through the second CG-PUSCH (S4240).

A CSI report may be prepared at a time when a third CG-PUSCH is allocated. The terminal may multiplex an RRC reconfiguration complete message and the CSI report based on the multiplexing transmission configuration of the RRC reconfiguration message previously received from the source cell. The terminal may transmit, to the target cell, the multiplexed message through the third CG-PUSCH (S4250).

FIG. 43 is a sequence chart illustrating an exemplary embodiment of configured-grant-based multiplexed reporting of an RRC reconfiguration complete message and CSI by a terminal.

Referring to FIG. 43, a source cell may receive UE capability information from a terminal and may transmit, to the terminal, an RRC reconfiguration message based on the received UE capability information (S4310). The RRC reconfiguration message may include a multiplexing transmission configuration for a CSI report and an RRC reconfiguration complete message of the terminal.

The source cell may transmit, to the terminal, a cell switch command including information on a target cell (S4320). Based on the cell switch command, the terminal may release a connection with the source cell and perform cell switching to the target cell.

A CSI report may not be prepared at a time when a first CG-PUSCH is allocated. The terminal may transmit, to the target cell, a signal indicating that a CSI report is not prepared or an invalid CSI report through the first CG-PUSCH (S4330). In an exemplary embodiment, the terminal may not transmit any signal through the first CG-PUSCH. In addition, a CSI report may not be prepared at a time when a second CG-PUSCH is allocated. The terminal may transmit, to the target cell, a signal indicating that a CSI report is not prepared through the second CG-PUSCH (S4340).

A CSI report may be prepared at a time when a third CG-PUSCH is allocated. The terminal may multiplex an RRC reconfiguration complete message and the CSI report based on the multiplexing transmission configuration of the RRC reconfiguration message previously received from the source cell. The terminal may transmit, to the target cell, a valid CSI report multiplexed with the RRC reconfiguration complete message through the third CG-PUSCH (S4350).

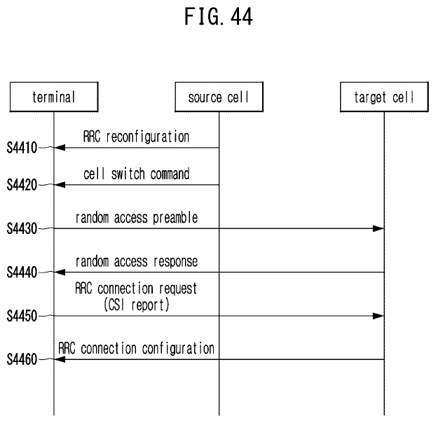

FIG. 44 is a sequence chart illustrating an exemplary embodiment of random-access-based CSI multiplexed reporting of a terminal.

Referring to FIG. 44, a source cell may receive UE capability information from a terminal and may transmit, to the terminal, an RRC reconfiguration message based on the received UE capability information (S4410). The RRC reconfiguration message may include an early CSI measurement configuration for the terminal.

The source cell may transmit, to the terminal, a cell switch command including information on a target cell (S4420). Based on the cell switch command, the terminal may release a connection with the source cell and perform cell switching to the target cell.

The terminal may perform a random access procedure with the target cell, for example, a four-step random access procedure. The terminal may transmit, to the target cell, Msg1 including a random access preamble (S4430). The target cell may receive Msg1 from the terminal and may transmit, to the terminal, a random access response, for example, Msg2 (S4440). The terminal may multiplex a CSI report and an RRC connection request message, for example, Msg3, based on Msg2 received from the target cell and may transmit, to the target cell, the multiplexed message (S4450). The target cell may determine an MCS of a DL signal based on the CSI report received from the terminal and may transmit, to the terminal, an RRC connection complete message, for example, Msg4, by using the DL signal (S4460).

Meanwhile, in FIG. 40 to FIG. 43, the terminal may determine invalidity of CSI (CSI values) as in Table 2 below.

TABLE 2

| Item | Valid condition | Invalid (null) condition |
|---|---|---|
| Channel quality | 1-15 | 0 |
| indicator (CQI) | | (transmission not |
| | | possible state) |
| Precoder matrix | PMI index matching a rank | PMI index not |
| indicator (PMI) | indicator (RI) | matching RI |

As in Table 2, data transmission of the terminal may be impossible when CQI is 0, and the remaining fields may become meaningless. For example, when CQI is 0, an RI field, a PMI field, or a CSI-RS resource indicator (CRI) field may be determined as an invalid value regardless of any value.

### [TCI State and CSI-RS Resources]

In an LTM procedure of a terminal according to the present disclosure, a TCI state (i.e. a target TCI state) of a target cell may be indicated by a cell switch command (CSC). A plurality of CSI-RS resources associated with the TCI state of the target cell may exist, and the terminal may measure CSI for each of the plurality of CSI-RS resources and may transmit, to the target cell, a CSI report including measured CSI (i.e. CSI values). The terminal may not transmit the CSI report along to the target cell and may transmit, to the target cell, the CSI report by multiplexing the CSI report and an RRC reconfiguration complete message on a PUSCH. The target cell may reduce a burden of blind decoding and stable and fast CSI reception may be possible. The terminal may transmit, to the target cell, an invalid CSI entry (e.g. CQI=0 and the like) for the CSI-RS resources associated with the TCI state of the target cell in the same CSI report format even when valid CSI does not exist, so that format consistency may be maintained. In other words, the terminal may transmit, to the target cell, a CSI report for each of the plurality of CSI-RS resources associated with the TCI state of the target cell, and the terminal may transmit, to the target cell, a CSI report in the same format including invalid CSI entries as many as the number of the corresponding resources even when valid CSI does not exist. Accordingly, the target cell may determine whether CSI is valid based on the same format structure.

### [Definition of Valid CSI and Discrimination Method Therefor]

CSI may not necessarily mean invalid CSI when a CQI value of the CSI is 0. For example, the CQI value may become 0 when a channel state is poor. Therefore, the terminal may determine that CSI is invalid when both a CQI value and an RI value are 0 or when the CQI value is 0 and PMI and RI do not match. In other words, valid CSI may mean CSI in which a combination of CQI, RI, or PMI is configured as values calculated based on a physical channel state, and invalid CSI may mean CSI of a combination in which the CQI value is 0 and the RI value is 0 or PMI is not configured. Based on such a combination, validity and invalidity of CSI may be clearly discriminated.

[Multiplexing of uplink control information (UCI) and uplink shared channel (UL-SCH)] In order to prevent blind decoding of a target cell and to guarantee reception stability, the terminal may multiplex and transmit a CSI report and an uplink message such as an RRC reconfiguration complete message in the same PUSCH when the CSI report is valid.

In other words, the target cell may have a burden of blind decoding for a CSI report when the terminal transmits the CSI report alone. Therefore, a structure in which UCI such as a CSI report and an RRC reconfiguration complete message are multiplexed in the same PUSCH may be required. Such a structure may be equally applied in a scenario of an initial uplink grant based on a random access procedure or in a scenario in which a random access procedure is omitted.

[Possibility of reception failure of an RRC reconfiguration complete message due to interpretation of a CQI value as 0, and a method for preventing the failure]

The terminal may report, to a target cell, valid CSI through UCI when valid CSI is acquired after receiving a cell switch command. The terminal may multiplex the UCI and an RRC reconfiguration complete message and may transmit, to the target cell, the multiplexed UCI and RRC reconfiguration completion message in the same PUSCH. Here, when a CQI value of CSI is 0, the CSI may be valid CSI in which channel quality is very low, or may be invalid CSI transmitted in a state in which valid CSI is not acquired.

When the terminal identifies that the CQI value is 0 and regards the CSI as invalid CSI, the target cell may omit decoding of an LDPC coding block (e.g. UL-SCH region) after the UCI included in the uplink transmission. Such an operation is a method in which, after checking only UCI including CQI=0 on the PUSCH, LDPC decoding is not performed for UL-SCH under an assumption that valid data do not exist in UL-SCH.

In this case, although the terminal multiplexes and transmits the RRC reconfiguration complete message together, a base station of the target cell may fail to receive the RRC reconfiguration complete message, and a problem may occur. As a result, completion of the RRC procedure between the terminal and the target base station may be omitted, and this may cause failure of the LTM procedure of the terminal.

Therefore, in order to prevent interpretation that CQI=0 always means invalid CSI, a structure in which validity of CSI may be clearly determined through a combination of CQI, RI, or PMI may be required. For example, even when the CQI value is 0, the CSI may be regarded as valid CSI when a valid or matching combination of RI and PMI is reported together. In this case, the target cell may perform LDPC decoding for UL-SCH transmitted after the valid CSI and may identify the RRC reconfiguration complete message. In contrast, in the case of invalid CSI, a CSI report may be configured as a combination in which the CQI value is 0 and RI and PMI are invalid or do not match. The target cell may not perform LDPC decoding for UL-SCH transmitted after the invalid CSI, thereby reducing power consumption caused by unnecessary decoding.

### [CSI-RS Resource Configuration and Subset Selection Before Reception of a Cell Switch Command]

### 1. Initial CSI-RS Resource Configuration According to RRC Configuration

The terminal may receive, from a source cell, a CSI-RS resource set for acquiring CSI for each of a plurality of candidate cells periodically through an RRC reconfiguration message. The CSI-RS resource set may be configured in a limited number in consideration of a CSI reception capability of the terminal (e.g. a number of CSI-RSs or a number of ports that are capable of simultaneous reception).

### 2. Terminal Measurement Operation for all Configured Resources

The terminal may perform CSI measurement for all CSI-RS resources.

### 3. Subset Indication (Signaling-Based CSI-RS Subset Selection)

When the number of the plurality of candidate cells is reduced by the source cell, in other words, when the candidate cells are narrowed, the network may explicitly indicate, to the terminal, a subset of specific CSI-RS resources through a MAC CE, an RRC message, or DCI. The terminal may perform CSI measurement for CSI-RS resources included in the message, and may exclude remaining CSI-RS resources not included in the message from CSI measurement.

4. Terminal Operation when a Message for Subset Selection is Absent

When the network does not indicate a subset, the terminal may perform CSI measurement for all CSI-RS resources. This is on the premise that CSI of a specific candidate cell among the plurality of candidate cells may be secured even though subset indication of the terminal is not present.

### 5. Problem in Case of No CSI Measurement

When the terminal does not perform CSI measurement although the terminal receives a CSI-RS, the network may misunderstand that the terminal holds valid CSI. As a result, the network may misjudge an operation of the terminal (e.g. a UCI-based CSI report) after a cell switch command, and a problem may be caused.

[Subset Cell Measurement and Reporting Based on TCI State after Reception of a Cell Switch Command]

### 1. Inclusion of Target TCI State in Cell Switch Command

A cell switch command may indicate, to a terminal, switching to a target cell and may include a TCI state indicating a beam to be switched. The TCI state may be associated with one or more CSI-RS resources.

### 2. QCL-Based or Explicit Mapping

The terminal may determine CSI-RS resources associated with the TCI state according to a Quality Co-location (QCL) relationship or mapping information at a time of RRC configuration. When the TCI state corresponds to a wide beam (QCL RS), the TCI state may include a plurality of narrow beams (CSI-RSs) under the TCI state.

### 3. Execution of Subset CSI-RS Measurement

The terminal may perform CSI measurement for CSI-RS resources associated with the TCI state after receiving the cell switch command. The terminal may efficiently grasp a channel state of the target cell without measuring all CSI-RS resources.

### 4. CSI Reporting Based on UCI

The terminal may report measured CSI in a UCI format and may transmit, to the target cell, a CSI report by multiplexing the CSI report and an RRC reconfiguration complete message on a PUSCH. When a plurality of CSI-RSs are associated, the terminal may include, in the CSI report, all CSI entries (CQI, RI, PMI, and the like) for each of the plurality of CSI-RSs.

### [Allowance of Inter-Frequency for CSI Acquisition]

The 3GPP standards allow L1-RSRP-based measurement for candidate cells to be performed not only in intra-frequency but also in inter-frequency, and the terminal may determine a target cell by previously evaluating beam quality of candidate cells existing in various frequency bands.

However, when an inter-frequency candidate cell is not allowed in terms of CSI acquisition, the terminal may not acquire CSI of a cell even when the cell located in inter-frequency among the plurality of candidate cells is selected as a target cell. In this case, an intra-frequency-based measurement performed before the terminal receives a cell switch command may become practically meaningless regardless of the target cell, and this may have a negative influence on beam optimization and efficient scheduling of the LTM procedure. Therefore, an inter-frequency cell used in L1-RSRP measurement for determining the target cell may need to be included as a cell for CSI measurement.

From a physical layer perspective, CSI-RS measurement of the terminal is performed according to a capability of the terminal, and the network configures CSI-RS resources based on the capability of the terminal, so that there is no need to restrict inter-frequency in advance. Therefore, CSI acquisition for candidate cells may be configured to support both intra-frequency and inter-frequency within a capability range of the terminal, and such a configuration may be realized through UE capability reporting or RRC configuration.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a source cell, a radio resource control (RRC) reconfiguration message;
measuring a signal strength of each of a plurality of channel state information-reference signals (CSI-RSs) respectively received from a plurality of candidate cells, based on the RRC reconfiguration message;
transmitting, to the source cell, a measurement result of the signal strengths;
receiving, from the source cell, a CSI-RS activation indication message for each of at least two candidate cells among the plurality of candidate cells, based on the measurement result of the signal strengths;
receiving, from the source cell, a cell switch command (CSC) for a target cell among the at least two candidate cells; and
transmitting, for performing cell switching from the source cell to the target cell based on the cell switch command, a multiplexed message including a CSI report based on a CSI measurement result for the target cell and an RRC reconfiguration complete message.

2. The method of claim 1, further comprising, before receiving the cell switch command, measuring, based on the CSI-RS activation indication message, CSI for the CSI-RS of each of the at least two candidate cells.

3. The method of claim 1, further comprising, after receiving the cell switch command, measuring, based on at least one of the cell switch command or a CSI measurement indicator field included in the cell switch command, CSI for the CSI-RS of the target cell among the at least two candidate cells.

4. The method of claim 1, wherein the transmitting of the multiplexed message comprises:
receiving, from the target cell, a CSI report request; and
transmitting, to the target cell, the multiplexed message including a physical uplink shared channel (PUSCH) to which the RRC reconfiguration complete message is allocated and an uplink control indicator (UCI) control channel to which the CSI report for the target cell is allocated, based on the CSI report request.

5. The method of claim 4, further comprising: based on the CSI report for the target cell being invalid at a time of receiving the CSI report request, transmitting, to the target cell, an invalid CSI report,
wherein the invalid CSI report is determined based on a combination of a channel quality indicator (CQI), a precoding matrix indicator (PMI), or a rank indicator (RI) of the CSI measurement result.

6. The method of claim 1, wherein the transmitting of the multiplexed message comprises: transmitting the multiplexed message using a periodically allocated PUSCH.

7. The method of claim 6, further comprising: based on the CSI report for the target cell being invalid at a time of allocating the PUSCH, transmitting, to the target cell, an invalid CSI report.

8. The method of claim 1, wherein the RRC reconfiguration message includes a list of CSI-RSs to be measured for signal strength, and the measuring of the signal strength of each of the plurality of CSI-RSs comprises: excluding, from the list, at least one CSI-RS showing a decreasing trend in signal strength among the plurality of CSI-RSs.

9. The method of claim 1, wherein the RRC reconfiguration message includes a list of CSI-RSs to be measured for signal strength, and the measuring of the signal strength of each of the plurality of CSI-RSs comprises:
transmitting, to the source cell, a measurement exclusion request for at least one CSI-RS showing a decreasing trend in signal strength among the plurality of CSI-RSs; and
receiving, from the source cell, an updated signal strength measurement target list from which the at least one CSI-RS is excluded.

10. A terminal comprising at least one processor, wherein the at least one processor causes the terminal to perform:
receiving, from a source cell, a radio resource control (RRC) reconfiguration message;
measuring a signal strength of each of a plurality of channel state information-reference signals (CSI-RSs) respectively received from a plurality of candidate cells, based on the RRC reconfiguration message;
transmitting, to the source cell, a measurement result of the signal strengths;
receiving, from the source cell, a CSI-RS activation indication message for each of at least two candidate cells among the plurality of candidate cells, based on the measurement result of the signal strengths;
receiving, from the source cell, a cell switch command (CSC) for a target cell among the at least two candidate cells; and
transmitting, for performing cell switching from the source cell to the target cell based on the cell switch command, a multiplexed message including a CSI report based on a CSI measurement result for the target cell and an RRC reconfiguration complete message.

11. The terminal of claim 10, wherein the at least one processor further causes the terminal to perform: before receiving the cell switch command, measuring, based on the CSI-RS activation indication message, CSI for the CSI-RS of each of the at least two candidate cells.

12. The terminal of claim 10, wherein the at least one processor further causes the terminal to perform: after receiving the cell switch command, measuring, based on at least one of the cell switch command or a CSI measurement indicator field included in the cell switch command, CSI for the CSI-RS of the target cell among the at least two candidate cells.

13. The terminal of claim 10, wherein in the transmitting of the multiplexed message, the at least one processor causes the terminal to perform:
receiving, from the target cell, a CSI report request; and
transmitting, to the target cell, the multiplexed message including a physical uplink shared channel (PUSCH) to which the RRC reconfiguration complete message is allocated and an uplink control indicator (UCI) control channel to which the CSI report for the target cell is allocated, based on the CSI report request.

14. The terminal of claim 13, wherein the at least one processor further causes the terminal to perform: based on the CSI report for the target cell being invalid at a time of receiving the CSI report request, transmitting, to the target cell, an invalid CSI report,
wherein the invalid CSI report is determined based on a combination of a channel quality indicator (CQI), a precoding matrix indicator (PMI), or a rank indicator (RI) of the CSI measurement result.

15. The terminal of claim 10, wherein in the transmitting of the multiplexed message, the at least one processor causes the terminal to perform: transmitting the multiplexed message using a periodically allocated PUSCH.

16. The terminal of claim 15, wherein the at least one processor further causes the terminal to perform: based on the CSI report for the target cell being invalid at a time of allocating the PUSCH, transmitting, to the target cell, an invalid CSI report.

17. The terminal of claim 10, wherein the RRC reconfiguration message includes a list of CSI-RSs to be measured for signal strength, and in the measuring of the signal strength of each of the plurality of CSI-RSs, the at least one processor causes the terminal to perform: excluding, from the list, at least one CSI-RS showing a decreasing trend in signal strength among the plurality of CSI-RSs.

18. The terminal of claim 10, wherein the RRC reconfiguration message includes a list of CSI-RSs to be measured for signal strength, and in the measuring of the signal strength of each of the plurality of CSI-RSs, the at least one processor causes the terminal to perform:
transmitting, to the source cell, a measurement exclusion request for at least one CSI-RS showing a decreasing trend in signal strength among the plurality of CSI-RSs; and
receiving, from the source cell, an updated signal strength measurement target list from which the at least one CSI-RS is excluded.

19. A method of a target cell, comprising:
transmitting, to a terminal, at least one channel state information-reference signal (CSI-RS) based on a CSI-RS request received from a source cell; and
after the terminal receives a cell switch command from the source cell, receiving, from the terminal, a multiplexed message of a CSI report for the target cell and a radio resource control (RRC) reconfiguration complete message.

20. The method of claim 19, wherein the receiving of the multiplexed message comprises:
transmitting, to the terminal, a CSI report request; and
receiving, from the terminal, the multiplexed message through one physical uplink shared channel (PUSCH) based on the CSI report request.
